(19) United States
(12) Patent Application Publication
(10) Pub. No.: US 2015/0131624 A1
(43) Pub. Date: May 14, 2015

(54) SYSTEMS AND METHODS FOR PROTECTING LOW-RATE COMMUNICATIONS IN HIGH-EFFICIENCY WIRELESS NETWORKS

(71) Applicant: QUALCOMM Incorporated, San Diego, CA (US)

(72) Inventors: Simone MERLIN, Solana Beach, CA (US); Rahul Tandra, San Diego, CA (US); Sameer Vermani, San Diego, CA (US); Gwendolyn Denise Barriac, Encinitas, CA (US)

(21) Appl. No.: 14/534,020

(22) Filed: Nov. 5, 2014

Related U.S. Application Data
(60) Provisional application No. 61/902,097, filed on Nov. 8, 2013.

(51) Int. Cl. H04W 72/04; H04W 52/24; H04W 72/08

(52) U.S. Cl. CPC H04W 72/0446; H04W 72/082; H04W 52/243; H04W 84/12
USPC 370/336; 370/338

(57) ABSTRACT

Systems, methods, and devices for wireless communication in an IEEE 802.11 wireless communication system including legacy and high-efficiency wireless (HEW) devices are described herein. In some aspects, a method includes configuring transmission of a first communication for at least partially protecting reception of a second communication. The method further includes transmitting the first communication, the first communication being decodable by the legacy devices. The method further includes transmitting the second communication, the second communication being decodable by the HEW devices.

### CROSS-REFERENCE TO RELATED APPLICATIONS

This application claims priority to U.S. Provisional Patent Application No. 61/902,097, entitled “SYSTEMS AND METHODS FOR PROTECTING LOW-RATE COMMUNICATIONS IN HIGH-EFFICIENCY WIRELESS NETWORKS” and filed Nov. 8, 2013, the entirety of which is incorporated herein by reference.

### FIELD

The present application relates generally to wireless communications, and more specifically to systems, methods, and devices for protecting low-rate communications in high-efficiency wireless networks.

### BACKGROUND

In many telecommunication systems, communications networks are used to exchange messages among several interacting spatially-separated devices. Networks may be classified according to geographic scope, which may be, for example, a metropolitan area, a local area, or a personal area. Such networks may be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

However, multiple wireless networks may exist in the same building, in nearby buildings, and/or in the same outdoor area, and various devices can operate according to different wireless standards. The prevalence of multiple wireless standards may cause interference, reduced throughput (e.g., because each wireless network is operating in the same area and/or spectrum), and/or prevent certain devices from communicating. Thus, improved systems, methods, and devices for communicating in multi-standard environments are desired.

### SUMMARY

The systems, methods, and devices of the present disclosure each have several aspects, no single one of which is solely responsible for its desirable attributes. Without limiting the scope of the disclosure as expressed by the claims which follow, some features will now be described briefly. After considering this description, and particularly after reading the section entitled “Detailed Description,” one will understand how the features described in the disclosure provide advantages that include improved communications between access points and stations in a wireless network.

One aspect of the present disclosure provides a method of wireless communication in an IEEE 802.11 wireless communication system including legacy and high-efficiency wireless (HEW) devices. The method includes configuring transmission of a first communication for at least partially protecting reception of a second communication. The method further includes transmitting the first communication, the first communication being decodable by the legacy devices. The method further includes transmitting the second communication, the second communication being decodable by the HEW devices.

In various embodiments, the first communication may comprise a frame or at least a portion of a preamble for the second communication, thereby partially protecting reception of the second communication and the second communication comprises a frame. In such embodiments, the first communication may comprise a preamble indicating a duration longer than a duration of a frame containing the preamble, thereby partially protecting reception of the second communication.

In other various embodiments, the second communication comprises a physical layer convergence protocol data unit. In other various embodiments, the first communication uses a bandwidth greater than or equal to 20 MHz, and the second communication uses a bandwidth less than 20 MHz. In other various embodiments, the first and second communications use a bandwidth greater than or equal to 20 MHz. In other various embodiments, the method further comprises transmitting a third communication after waiting a predetermined amount of time, the third communication being decodable by the HEW devices, and the transmitting of the first communication at least partially protects reception of the third communication. In other various embodiments, the transmitting of the first communication is at a first power level, and the transmitting of the second communication is at a second power level, the first power level being greater than the second power level, thereby partially protecting reception of the second communication. In other various embodiments, the first communication comprises a clear-to-send frame or a portion of a preamble for the second communication, thereby partially protecting reception of the second communication, and the second communication comprises a ready-to-send frame.

In other various embodiments, the method further comprises waiting a predetermined amount of time to receive a subsequent clear-to-send frame decodable by the HEW devices, wherein the transmission of the first communication at least partially protects reception of the subsequent clear-to-send frame. In such embodiments, the method may further comprise transmitting, after the earliest of receiving the subsequent clear-to-send frame or waiting the predetermined amount of time, a physical layer convergence protocol data unit decodable by the HEW devices, wherein the transmission of the first communication at least partially protects reception of the physical layer convergence protocol data unit.

Another aspect provides an apparatus configured for wireless communication in an IEEE 802.11 wireless communication system including legacy and high-efficiency wireless (HEW) devices. The apparatus includes one or more processors. The apparatus further includes a transmitter, receiver, and/or transceiver configured to configure transmission of a first communication for at least partially protecting reception of a second communication. The transmitter, receiver, and/or transceiver may also be configured to transmit the first communication, the first communication being decodable by the legacy devices. The transmitter, receiver, and/or transceiver may also be configured to transmit the second communication, the second communication being decodable by the HEW devices.

In various embodiments, the first communication can comprise a frame or at least a portion of a preamble for the second communication, thereby partially protecting reception of the second communication and the second communication can comprise a frame. In such embodiments, the first communication may comprise a preamble indicating a duration longer than a duration of a frame containing the preamble, thereby partially protecting reception of the second communication.

In other various embodiments, the second communication comprises a physical layer convergence protocol data unit. In other various embodiments, the first communication uses a bandwidth greater than or equal to 20 MHz, and the second communication uses a bandwidth less than 20 MHz. In other various embodiments, the first and second communications use a bandwidth greater than or equal to 20 MHz. In other various embodiments, transmitter, receiver, and/or transceiver may be further configured to transmit a third communication after waiting a predetermined amount of time, the third communication being decodable by the HEW devices. In such embodiments, the transmitting of the first communication may at least partially protect reception of the third communication.

In other various embodiments, the transmitting of the first communication is at a first power level, and the transmitting of the second communication is at a second power level, the first power level being greater than the second power level, thereby partially protecting reception of the second communication. In other various embodiments, the first communication comprises a clear-to-send frame or a portion of a preamble for the second communication, thereby partially protecting reception of the second communication, and the second communication comprises a ready-to-send frame.

In other various embodiments, the transmitter, receiver, and/or transceiver may be further configured to wait a predetermined amount of time to receive a subsequent clear-to-send frame decodable by the HEW devices, wherein the transmission of the first communication at least partially protects reception of the subsequent clear-to-send frame. In such embodiments, the transmitter, receiver, and/or transceiver may be further configured to transmit, after the earliest of receiving the subsequent clear-to-send frame or waiting the predetermined amount of time, a physical layer convergence protocol data unit decodable by the HEW devices, wherein the transmission of the first communication at least partially protects reception of the physical layer convergence protocol data unit.

Another aspect provides an apparatus comprising means for configuring transmission of a first communication for at least partially protecting reception of a second communication. The apparatus further comprises means for transmitting the first communication, the first communication being decodable by legacy devices. The apparatus further comprises means for transmitting the second communication, the second communication being decodable by HEW devices.

Another aspect provides a non-transitory computer-readable storage medium, comprising code that, when executed on one or more processors, causes an apparatus to configure transmission of a first communication for at least partially protecting reception of a second communication. The medium further comprises code that, when executed on one or more processors, causes an apparatus to transmit the first communication, the first communication being decodable by legacy devices. The medium further comprises code that, when executed on one or more processors, causes an apparatus to transmit the second communication, the second communication being decodable by HEW device.

### BRIEF DESCRIPTION OF THE DRAWINGS

FIG. 1 shows an exemplary wireless communication system in which aspects of the present disclosure may be employed.

FIG. 2 shows a wireless communication system in which multiple wireless communication networks are present.

FIG. 3 shows another wireless communication system in which multiple wireless communication networks are present.

FIG. 4 shows a functional block diagram of an exemplary wireless device that may be employed within the wireless communication systems of FIGS. 1-3.

FIG. 5 is a timing diagram showing various communications in the wireless communication system of FIG. 3, according to an embodiment.

FIG. 6 is another timing diagram showing various communications in the wireless communication system of FIG. 3, according to an embodiment.

FIG. 7 is another timing diagram showing various communications in the wireless communication system of FIG. 3, according to an embodiment.

FIG. 8 is another timing diagram showing various communications in the wireless communication system of FIG. 3, according to an embodiment.

FIG. 9 is another timing diagram showing various communications in the wireless communication system of FIG. 3, according to an embodiment.

FIG. 10 is another timing diagram showing various communications in the wireless communication system of FIG. 3, according to an embodiment.

FIG. 11 is another timing diagram showing various communications in the wireless communication system of FIG. 3, according to an embodiment.

FIG. 12 is another timing diagram showing various communications in the wireless communication system of FIG. 3, according to an embodiment.

FIG. 13 is another timing diagram showing various communications in the wireless communication system of FIG. 3, according to an embodiment.

FIG. 14 is another timing diagram showing various communications in the wireless communication system of FIG. 3, according to an embodiment.

FIG. 15 is another timing diagram showing various communications in the wireless communication system of FIG. 3, according to an embodiment.

FIG. 16 is another timing diagram showing various communications in the wireless communication system of FIG. 3, according to an embodiment.

FIG. 17 is another timing diagram showing various communications in the wireless communication system of FIG. 3, according to an embodiment.

FIG. 18 is another timing diagram showing various communications in the wireless communication system of FIG. 3, according to an embodiment.

FIG. 19 is a flowchart 1900 of an exemplary method of wireless communication.

FIG. 20 is a flowchart 2000 of another exemplary method of wireless communication.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. The scope of the disclosure covers any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure covers such an apparatus or method which is practiced using other structure, functionality, or structure and functionality in addition to or other than the various aspects of the disclosure set forth herein. Any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not limited to particular benefits, uses, or objectives. Rather, aspects of the disclosure are broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to the 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for Internet access, sensors, metering, smart grid networks, or other wireless applications. Advantageously, aspects of certain devices implementing the 802.11 protocol using the techniques disclosed herein may include allowing for increased peer-to-peer services (e.g., Miracast, WiFi Direct Services, Social WiFi, etc.) in the same area, supporting increased per-user minimum throughput requirements (if any), supporting more users, providing improved outdoor coverage and robustness, and/or consuming less power than devices implementing other wireless protocols.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

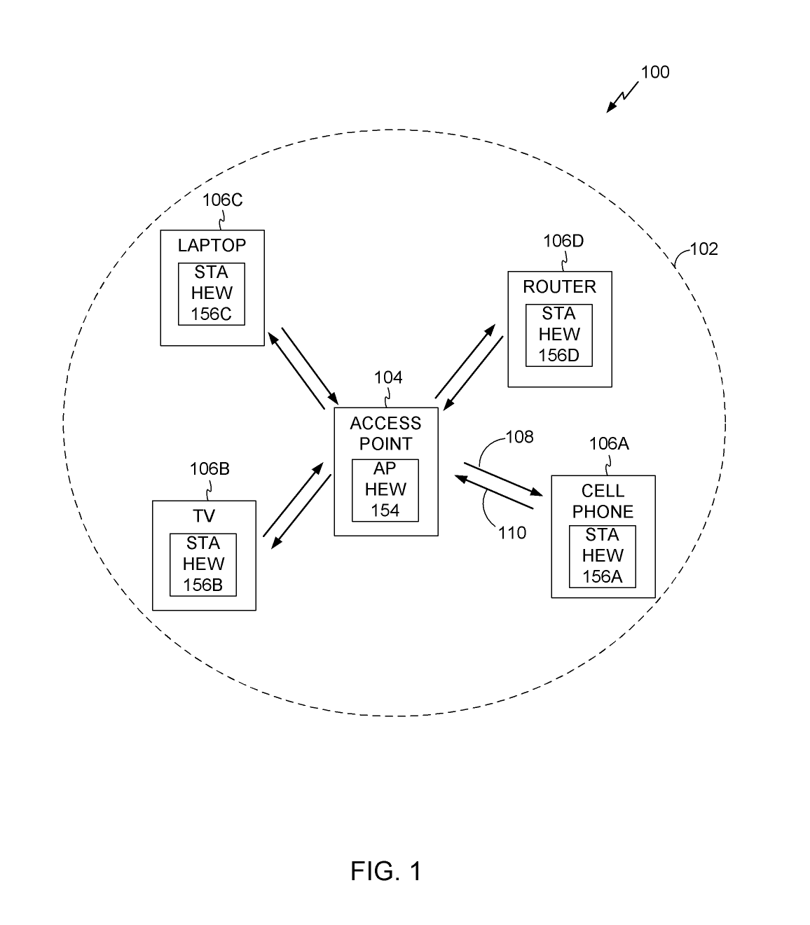

FIG. 1 shows an exemplary wireless communication system 100 in which aspects of the present disclosure may be employed. The wireless communication system 100 may operate pursuant to a wireless standard, for example a high-efficiency 802.11 standard. The wireless communication system 100 may include an access point (AP) 104, which communicates with STAs 106A-106D (generically referred to herein as STA(s) 106).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with code division multiple access (CDMA) techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). In one aspect, the wireless communication system 100 may not have a central AP 104, but rather may function as a peer-to-peer network between the STAs 106. Accordingly, the functions of the AP 104 described herein may alternatively be performed by one or more of the STAs 106.

In some aspects, a STA 106 may generally associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region (e.g., in a lighthouse fashion). After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

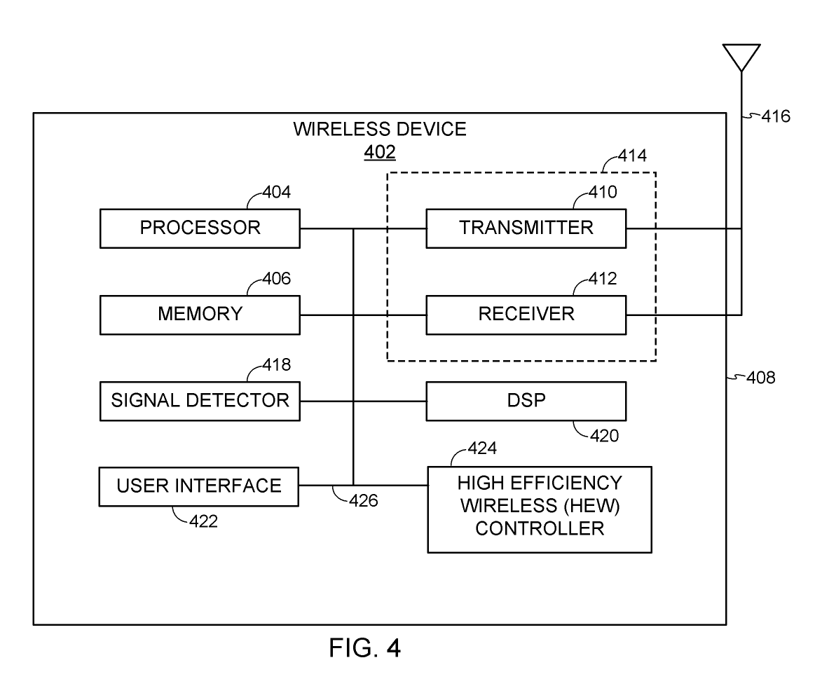

In an embodiment, the AP 104 includes an AP high efficiency wireless controller (or high-efficiency wireless (HEW) device) 154. The AP HEW 154 may perform some or all of the operations described herein to enable communications between the AP 104 and the STAs 106 using the 802.11 protocol. The functionality of the AP HEW 154 is described in greater detail below with respect to FIGS. 4-20.

Alternatively or in addition, the STAs 106 may include a STA HEW 156. The STA HEW 156 may perform some or all of the operations described herein to enable communications between the STAs 106 and the AP 104 using the 802.11 protocol. The functionality of the STA HEW 156 is described in greater detail below with respect to FIGS. 4-20.

A number of different methods, devices, and/or algorithms for configuring one or more transmissions to a legacy device (e.g., a non-HEW device) and/or a HEW device have been disclosed, that each or in a combination, and in practice and implementation would allow for management of wireless interference in the 802.11 communication system such that both legacy devices and HEW devices are able to receive communication and coexist in proximity with each other.

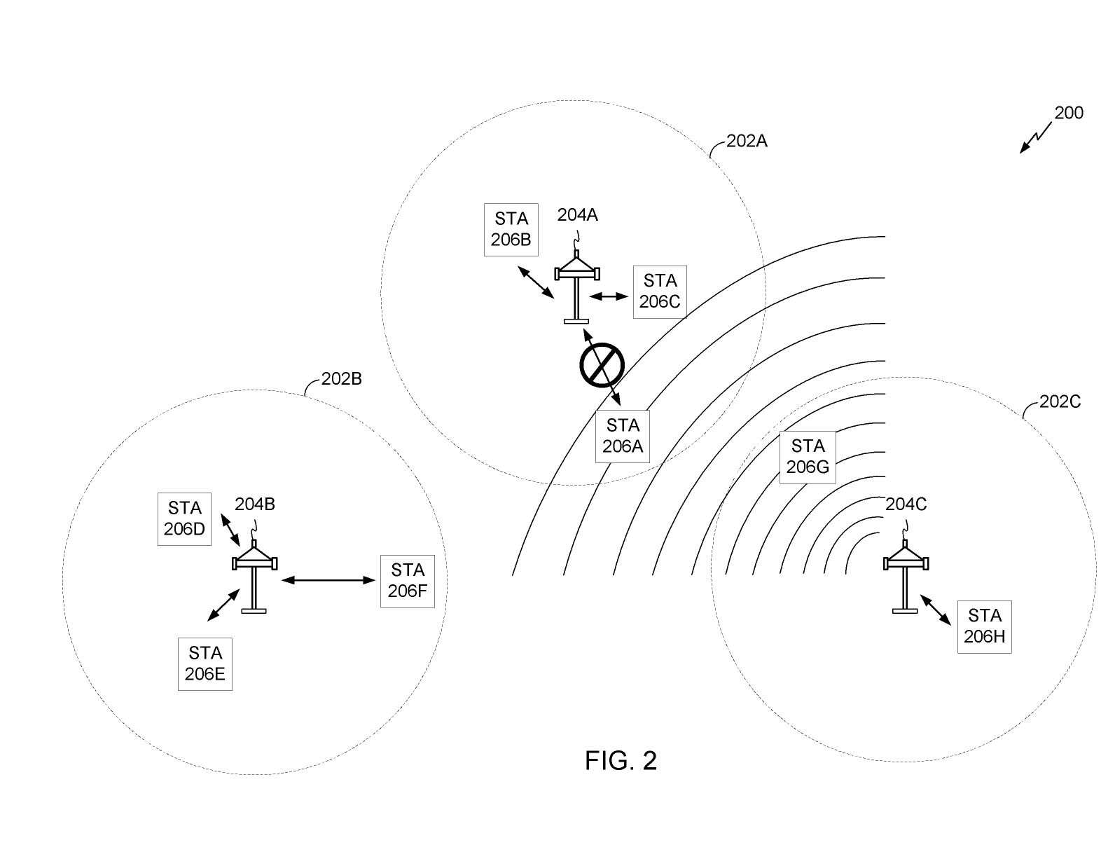

In some circumstances, a BSA may be located near other BSAs. For example, FIG. 2 shows a wireless communication system 200 in which multiple wireless communication networks are present. As illustrated in FIG. 2, BSAs 202A, 202B, and 202C may be physically located near each other. Despite the close proximity of the BSAs 202A-C, the APs 204A-C and/or STAs 206A-H may each communicate using the same spectrum. Thus, if a device in the BSA 202C (e.g., the AP 204C) is transmitting data, devices outside the BSA 202C (e.g., APs 204A-B or STAs 206A-F) may sense the communication on the medium.

Generally, wireless networks that use a regular 802.11 protocol (e.g., 802.11a, 802.11b, 802.11g, 802.11n, etc.) operate under a carrier sense multiple access (CSMA) mechanism for medium access. According to CSMA, devices sense the medium and only transmit when the medium is sensed to be idle. Thus, if the APs 204A-C and/or STAs 206A-H are operating according to the CSMA mechanism and a device in the BSA 202C (e.g., the AP 204C) is transmitting data, then the APs 204A-B and/or STAs 206A-F outside of the BSA 202C may not transmit over the medium even though they are part of a different BSA.

FIG. 2 illustrates such a situation. As illustrated in FIG. 2, AP 204C is transmitting over the medium. The transmission is sensed by STA 206G, which is in the same BSA 202C as the AP 204C, and by STA 206A, which is in a different BSA than the AP 204C. While the transmission may be addressed to the STA 206G and/or only STAs in the BSA 202C, STA 206A nonetheless may not transmit or receive communications (e.g., to or from the AP 204A) until the AP 204C (and any other device) is no longer transmitting on the medium. Although not shown, the same may apply to STAs 206D-F in the BSA 202B and/or STAs 206B-C in the BSA 202A as well (e.g., if the transmission by the AP 204C is stronger such that the other STAs can sense the transmission on the medium). In some embodiments, such refraining from transmitting when another device is using the wireless medium can be referred to as “deferral.”

As described above, certain of the devices described herein may implement a high-efficiency 802.11 standard, for example 802.11HEW. Such devices, whether used as an STA or AP or other device, may be used for smart metering or be used in a smart grid network. These wireless communication systems may be used to provide sensor applications or be used in home automation. Wireless devices used in such systems may instead or in addition be used in a healthcare context, for example, for personal healthcare. They may also be used for surveillance, to enable extended-range Internet connectivity (e.g., for use with hotspots) or to implement machine-to-machine communications.

Accordingly, one or more devices described herein may implement one or more low rate (LR) modes, which in some examples may have low data rates (e.g., approximately 150 Kbps). Implementations may further have increased link budget gains (e.g., around 20 dB) over other wireless communications, such as 802.11b. In accordance with low data rates, if wireless nodes are configured for use in a home environment, certain aspects may be directed to implementations with good in-home coverage without power amplification. Furthermore, certain aspects may be directed to single-hop networking without using a MESH protocol. In addition, certain implementations may result in significant outdoor coverage improvement with power amplification over other wireless protocols. Furthermore, certain aspects may be directed to implementations that may accommodate large, outdoor delay-spread and reduced sensitivity to Doppler. Certain implementations may achieve similar local oscillator (LO) accuracy as traditional WiFi.

Accordingly, certain implementations are directed to sending wireless signals with low bandwidths in sub-gigahertz bands. For example, in one exemplary implementation, a symbol may be configured to be transmitted or received using a bandwidth of 1 MHz. HEW devices may be configured to operate in one of several modes. In one mode, symbols such as OFDM symbols may be transmitted or received using a bandwidth of 1 MHz. In another mode, symbols may be transmitted or received using a bandwidth of 2 MHz. Additional modes may also be provided for transmitting or receiving symbols using a bandwidth of 4 MHz, 8 MHz, 16 MHz, and the like. The bandwidth may also be referred to as the channel width. In various embodiments, certain LR modes can use a bandwidth less than 20 MHz, such as for example 5 MHz. In some embodiments, other LR modes can use a bandwidth greater than or equal to 20 MHz.

Each mode may use a different number of tones/subcarriers for transmitting the information. For example, in one implementation, a 1 MHz mode (corresponding to transmitting or receiving symbols using a bandwidth of 1 MHz) may use 32 tones. In one aspect, using a 1 MHz mode may provide for a 13 dB noise reduction as compared to a bandwidth such as 20 MHz. In addition, low rate techniques may be used to overcome effects such as frequency diversity losses due to a lower bandwidth which may result in 4-5 dB losses depending on channel conditions. To generate/evaluate symbols sent or received using 32 tones, a transform module can be configured to use a 32 point mode (e.g., a 32 point IFFT or FFT). The 32 tones may be allocated as data tones, pilot tones, guard tones, and a DC tone. In one implementation, 24 tones may be allocated as data tones, 2 tones may be allocated as pilot tones, five tones may be allocated as guard tones, and 1 tone may be reserved for the DC tone. In this implementation, the symbol duration may be configured to be 40 μs including cyclic prefix. Other tone allocations are also possible.

For example, a HEW device may be configured to generate a packet for transmission via a wireless signal using a bandwidth of 1 MHz. In one aspect, the bandwidth may be approximately 1 MHz where approximately 1 MHz may be within a range of 0.8 MHz to 1.2 MHz. The packet may comprise one or more OFDM symbols having 32 tones allocated as described using a DSP or other processor. A transform module in a transmit chain may be configured as an IFFT module operating according to a thirty-two point mode to convert the packet into a time domain signal. A transmitter may then be configured to transmit the packet.

Likewise, a HEW device may be configured to receive the packet over a bandwidth of 1 MHz. In one aspect, the bandwidth may be approximately 1 MHz where approximately 1 MHz may be within a range of 0.8 MHz to 1.2 MHz. The 1 MHz mode may support a modulation and coding scheme (MCS) for both a low data rate and a “normal” rate. According to some implementations, a preamble may be designed for a low rate mode that offers reliable detection and improved channel estimation as will be further described below. Each mode may be configured to use a corresponding preamble configured to optimize transmissions for the mode and desired characteristics.

In addition to a 1 MHz mode, a 2 MHz mode may additionally be available that may be used to transmit and receive symbols using 64 tones. In one implementation, the 64 tones may be allocated as 52 data tones, 4 pilot tones, 1 DC tone, and 7 guard tones. As such, a transform module may be configured to operate according to a 64 point mode when transmitting or receiving 2 MHz symbols. The symbol duration may also be 40 μs including cyclic prefix. Additional modes with different bandwidths (e.g., 4 MHz, 8 MHz, and 16 MHz) may be provided that may use transform modules operating in modes of corresponding different sizes (e.g., 128 point FFT, 256 point FFT, 512 point FFT, etc.). In addition, each of the modes described above may be configured additionally according to both a single user mode and a multi user mode. Wireless signals using bandwidths less than or equal to 2 MHz may provide various advantages for providing wireless nodes that are configured to meet global regulatory constraints over a broad range of bandwidth, power, and channel limitations.

In various embodiments, HEW stations implementing LR modes can operate in the same area as legacy stations (e.g., stations that do not implement LR modes). Thus, in various embodiments, legacy stations may not accurately detect LR transmissions and may not defer, thereby increasing interference. Particularly, in various embodiments, LR transmissions can have a longer range than non-LR transmissions, and LR transmissions in range can be undecodable by non-LR stations.

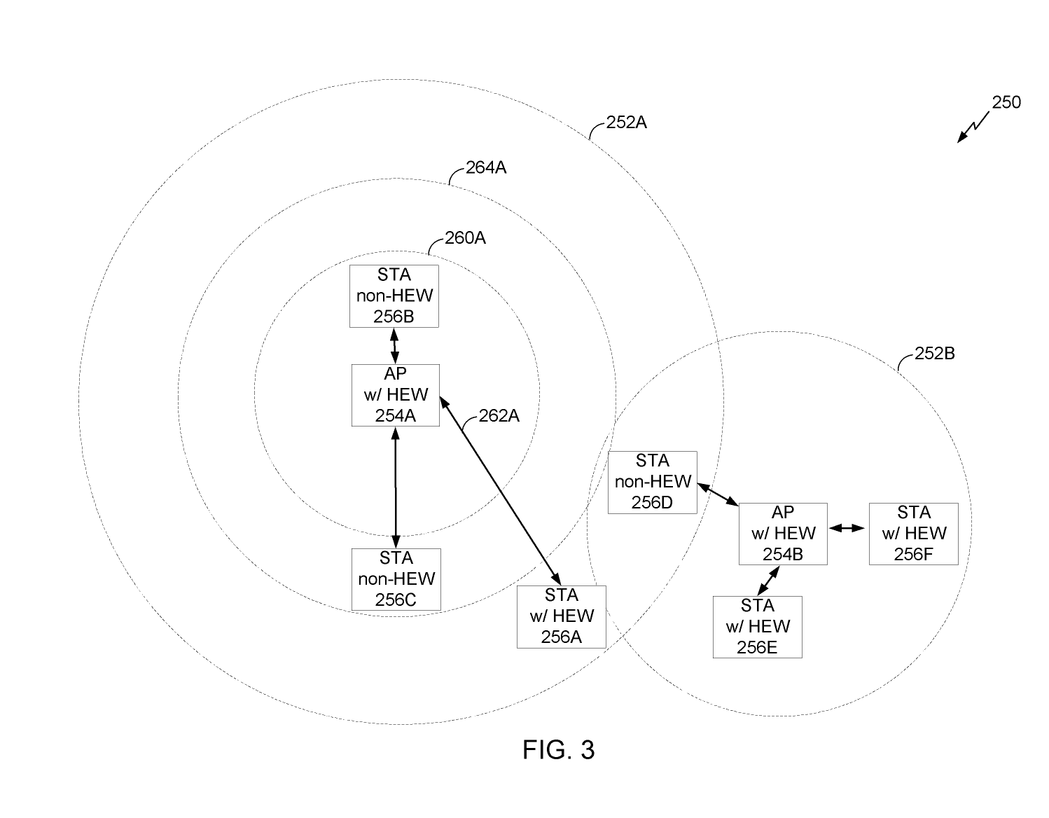

FIG. 3 shows a wireless communication system 250 in which high-efficiency wireless (HEW) devices and non-HEW devices are present. Unlike the wireless communication system 200 of FIG. 2, various devices in the wireless communication system 250 may operate pursuant to a high-efficiency 802.11 standard discussed herein. The wireless communication system 250 may include a HEW AP 254A and a HEW AP 254B. The HEW AP 254A may communicate with STAs 256A-C and the HEW AP 254B may communicate with STAs 256D-F. In various embodiments, the HEW APs 254A and 254B can belong to a common wireless network. In another embodiment, one or more of the HEW APs 254 can be non-HEW APs.

A variety of processes and methods may be used for transmissions in the wireless communication system 250 between the HEW APs 254A and 254B and the STAs 256A-256F. For example, signals may be sent and received between the HEW APs 254A and 254B and the STAs 256A-256F in accordance with OFDM/OFDMA techniques or CDMA techniques.

The HEW AP 254A may act as a base station and provide wireless communication coverage in a BSA 252A. The HEW AP 254B may act as a base station and provide wireless communication coverage in a BSA 252B. Each BSA 252A and 252B may not have a central HEW AP 254A or 254B, but rather may allow for peer-to-peer communications between one or more of the STAs 256A-256F. Accordingly, the functions of the HEW AP 254A and 254B described herein may alternatively be performed by one or more of the STAs 256A-256F.

In the illustrated embodiment, the HEW APs 254A and 254B and the STAs 256A, 256E, and 256F include a high efficiency wireless controller. As described herein, the high efficiency wireless controller can enable communications between the APs and STAs using the 802.11HEW protocol. In particular, the high efficiency wireless controller may enable the HEW APs 254A and 254B and the STAs 256A, 256E, and 256F to implement one or more LR modes, which in some embodiments can enable the HEW APs 254A and 254B and the STAs 256A, 256E, and 256F to communicate over greater distances than legacy STAs 256B, 256C, and 256D. The high efficiency wireless controller is described in greater detail below with respect to FIG. 4. In some embodiments, one or more of the STAs 256 can be a HEW STA and one or more of the STAs 256 can be a legacy STA (or a “non-HEW STA”).

As described above, the HEW APs and/or HEW STAs 254A, 254B, 256A, 256E, and 256F can be configured to operate in one or more LR modes having various compatibility with the legacy STAs 256B, 256C, and 256D. For example, the legacy STAs 256B, 256C, and 256D may be unable to decode transmissions having a first LR mode. The legacy STAs 256B, 256C, and 256D may be able to partially decode transmissions having a second LR mode. The legacy STAs 256B, 256C, and 256D may be able to fully decode transmissions having a third LR mode.

In various embodiments, in the first LR mode, the HEW APs 254A, 254B, 256A, 256E, and 256F can transmit and/or receive packets using a bandwidth inaccessible to the legacy STAs 256B, 256C, and 256D. In an embodiment, the HEW APs 254A, 254B, 256A, 256E, and 256F can transmit and/or receive packets using a bandwidth less than a bandwidth used by the legacy STAs 256B, 256C, and 256D. For example, the HEW APs 254A, 254B, 256A, 256E, and 256F can use packets having a bandwidth less than 20 MHz and the legacy STAs 256B, 256C, and 256D can use packets having a bandwidth greater than or equal to 20 MHz.

In other embodiments, in the first LR mode, the HEW APs and/or HEW STAs 254A, 254B, 256A, 256E, and 256F can transmit and/or receive packets using a bandwidth accessible to the legacy STAs 256B, 256C, and 256D. For example, the HEW APs 254A, 254B, 256A, 256E, and 256F can use packets having a bandwidth greater than or equal to 20 MHz and the legacy STAs 256B, 256C, and 256D can use packets having a bandwidth greater than or equal to 20 MHz. However, the HEW APs 254A, 254B, 256A, 256E, and 256F can transmit and/or receive packets using a format inaccessible to the legacy STAs 256B, 256C, and 256D.

In various embodiments, the HEW AP 254 and the HEW STA 256A can communicate using the first LR mode. In some embodiments, the legacy STA 256B, which is within an energy detection range 260A, can sense an LR transmission 262A. For example, when the legacy STA 256B is close to a transmitting HEW AP 254, the LR transmission 262A can surpass an energy detection threshold (such as, for example, −62 dB). Thus, the legacy STA 256B can defer to the LR transmission 262A despite being unable to access the LR transmission 262A itself.

On the other hand, the legacy STA 256C is outside the energy detection range 260A but within a legacy association and deferral range 264A in the illustrated embodiment. Thus, the LR transmission 262A does not surpass the energy detection threshold for the legacy STA 256C. Moreover, because the LR transmission 262A is inaccessible to the legacy STA 256C, the legacy STA 256C will not defer, and can therefore cause interference.

Similarly, the legacy STA 256D is outside the energy detection range 260A in the illustrated embodiment. The legacy STA 256D is also outside the legacy association and deferral range 264A. The legacy STA 256D is, however, close enough to the HEW STA 256 to interfere with the LR transmission 262A. Accordingly, the legacy STA 256C will not defer to a HEW AP 254A transmission, and can therefore cause interference (although in some cases the legacy STA 256C can be within an energy detection threshold for HEW STA 256A transmissions).

In various embodiments, in the second LR mode, the HEW APs 254A, 254B, 256A, 256E, and 256F can transmit and/or receive packets, a portion of which is accessible to the legacy STAs 256B, 256C, and a portion of which is inaccessible to the legacy STAs 256B, 256C. For example, the HEW APs 254A, 254B, 256A, 256E, and 256F can use a preamble, or portion thereof, having both a bandwidth and format accessible to the legacy STAs 256B, 256C, and 256D (e.g., a “legacy” portion such as a legacy STF, LTF, SIG field, etc.). The HEW APs 254A, 254B, 256A, 256E, and 256F can further transmit a portion of a packet having a bandwidth and/or format inaccessible to the legacy STAs 256B, 256C, and 256D. For example, a high-efficiency (HE) STF, LTF, SIG field, data portion, etc. can be inaccessible to legacy devices.

In various embodiments, the HEW AP 254 and the HEW STA 256A can communicate using the second LR mode. In some embodiments, the legacy STA 256B, which is within both the energy detection range 260A and the legacy association and deferral range 264A can sense the LR transmission 262A. For example, when the legacy STA 256B is close to a transmitting HEW AP 254, the LR transmission 262A can surpass an energy detection threshold (such as, for example, −62 dB). Moreover, a portion of the LR transmission 262A is accessible to the legacy STA 256B. Thus, the legacy STA 256B can defer to the LR transmission 262A.

Similarly, the legacy STA 256C is within the legacy association range and deferral 264A, although it is outside the energy detection range 260A. Thus, a portion of the LR transmission 262A is accessible to the legacy STA 256C. Accordingly, the legacy STA 256B can defer to the LR transmission 262A.

On the other hand, the legacy STA 256D is outside both the legacy association and deferral range 264A and the energy detection range 260A. Thus, no portion of the LR transmission 262A is accessible to the legacy STA 256D and the LR transmission 262A does not surpass an energy detection threshold. The legacy STA 256D is, however, close enough to the HEW STA 256 to interfere with the LR transmission 262A. Accordingly, the legacy STA 256C will not defer to a HEW AP 254A transmission, and can therefore cause interference (although in some cases the legacy STA 256C can be within an energy detection threshold for HEW STA 256A transmissions).

FIG. 4 shows an exemplary functional block diagram of a wireless device 402 that may be employed within the wireless communication systems 100, 200, and/or 250 of FIGS. 1-3. The wireless device 402 is an example of a device that may be configured to implement the various methods described herein. For example, the wireless device 402 may comprise the AP 104, one of the STAs 106, one of the HEW APs 254, and/or one of the STAs 256.

The wireless device 402 may include a processor 404 which controls operation of the wireless device 402. The processor 404 may also be referred to as a central processing unit (CPU). A memory 406, which may include both read-only memory (ROM) and random access memory (RAM), may provide instructions and data to the processor 404. A portion of the memory 406 may also include non-volatile random access memory (NVRAM). The processor 404 generally performs logical and arithmetic operations based on program instructions stored within the memory 406. The instructions in the memory 406 may be executable to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408 that may include a transmitter 410 and/or a receiver 412 to allow transmission and reception of data between the wireless device 402 and a remote location. The transmitter 410 and receiver 412 may be combined into a transceiver 414. An antenna 416 may be attached to the housing 408 and electrically coupled to the transceiver 414. The wireless device 402 may also include (not shown) multiple transmitters, multiple receivers, multiple transceivers, and/or multiple antennas.

The wireless device 402 may also include a signal detector 418 that may be used in an effort to detect and quantify the level of signals received by the transceiver 414. The signal detector 418 may detect such signals as total energy, energy per subcarrier per symbol, power spectral density and other signals. The wireless device 402 may also include a digital signal processor (DSP) 420 for use in processing signals. The DSP 420 may be configured to generate a packet for transmission. In some aspects, the packet can include a physical layer convergence protocol data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

The wireless devices 402 may further comprise a high efficiency wireless (HEW) controller 424 in some aspects. As described herein, the HEW controller 424 may enable APs and/or STAs to increase protection of LR transmissions from interference by legacy STAs. In various embodiments, the HEW controller 424 can be configured to implement any method, or portion thereof, described herein.

The various components of the wireless device 402 may be coupled together by a bus system 426. The bus system 426 may include a data bus, for example, as well as a power bus, a control signal bus, and a status signal bus in addition to the data bus. The components of the wireless device 402 may be coupled together or accept or provide inputs to each other using some other mechanism.

Although a number of separate components are illustrated in FIG. 4, those of skill in the art will recognize that one or more of the components may be combined or commonly implemented. For example, the processor 404 may be used to implement not only the functionality described above with respect to the processor 404, but also to implement the functionality described above with respect to the signal detector 418 and/or the DSP 420. Further, each of the components illustrated in FIG. 4 may be implemented using a plurality of separate elements.

The wireless device 402 may comprise an AP 104, a STA 106, a HEW AP 254, and/or a STA 256, and may be used to transmit and/or receive communications. That is, any of AP 104, STA 106, HEW AP 254, and/or STA 256 may serve as transmitter or receiver devices. Certain aspects contemplate signal detector 418 being used by software running on memory 406 and processor 404 to detect the presence of a transmitter or receiver.

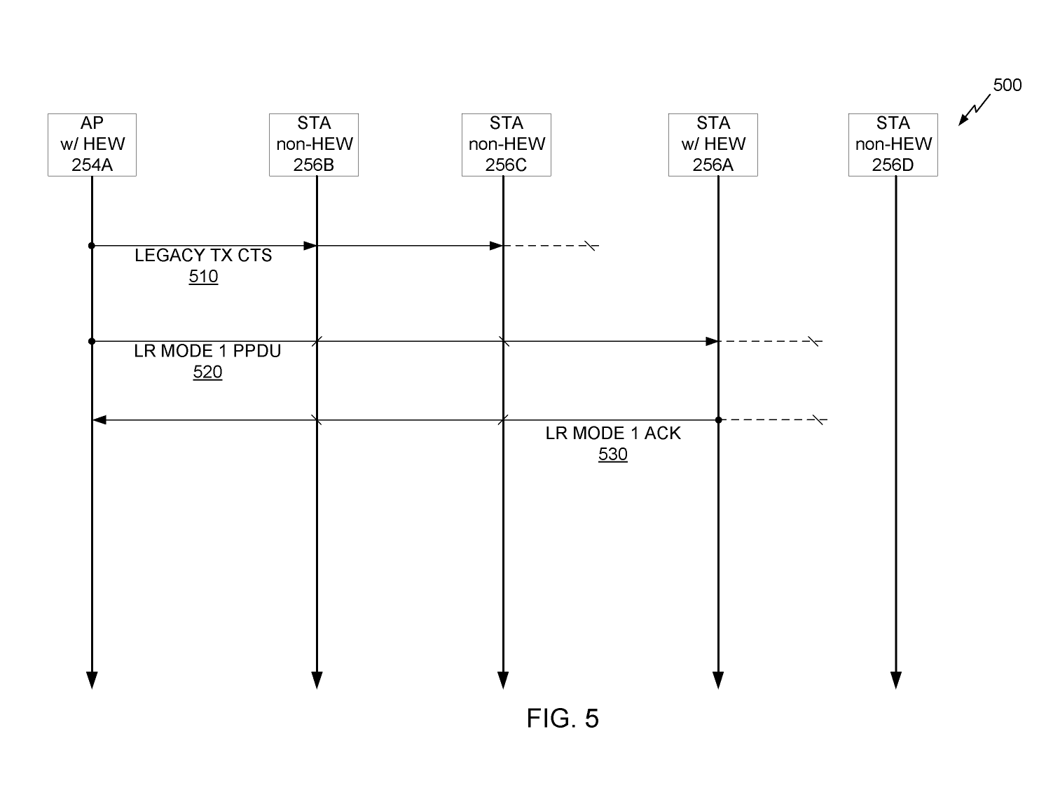

As described above with respect to FIG. 3, in various embodiments, legacy STAs can fail to defer to LR transmissions. Various approaches for at least partially protecting (e.g., partially protecting reception of) LR transmissions are described below with respect to FIGS. 5-19. Although FIGS. 5-19 are described with respect to the HEW AP 254 and the STAs 256A-256D of FIG. 3, the approaches described herein can be implemented by any suitable device.

### Protection for Mode 1

FIG. 5 is a timing diagram 500 showing various communications in the wireless communication system 250 of FIG. 3, according to an embodiment. As shown in the timing diagram 500, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 500 refers to the device configuration shown in FIG. 3, other configurations are possible including omission of various devices shown or addition of other devices. For example, in various embodiments, the HEW AP 254A can be replaced with a HEW STA. Moreover, although the timing diagram 500 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 5, the HEW AP 254A transmits a legacy clear-to-send (CTS) frame 510. The legacy CTS frame 510 can be a CTS-to-self frame and can set a network allocation vector (NAV) at least partially protecting the following LR transmissions. Because the legacy CTS frame 510 is not an LR transmission, it may only be received by devices within the legacy association and deferral range 264A (FIG. 3). Thus, the legacy STAs 256B and 256C can receive the legacy CTS frame 510 while the HEW STA 256A and the legacy STA 256D may not. Accordingly, the legacy STAs 256B and 256C can defer to the following LR transmissions and can refrain from transmitting until the NAV expires.

Next, the HEW AP 254A transmits an LR physical layer convergence protocol data unit (PPDU) 520 to the HEW STA 256A. The illustrated LR PPDU 520 is a mode 1 LR transmission. Accordingly, legacy STAs, even those within range, do not receive the LR PPDU 520. The HEW STA 256A sends an LR ACK 530 to the HEW AP 254A to acknowledge receipt of the LR PPDU 520.

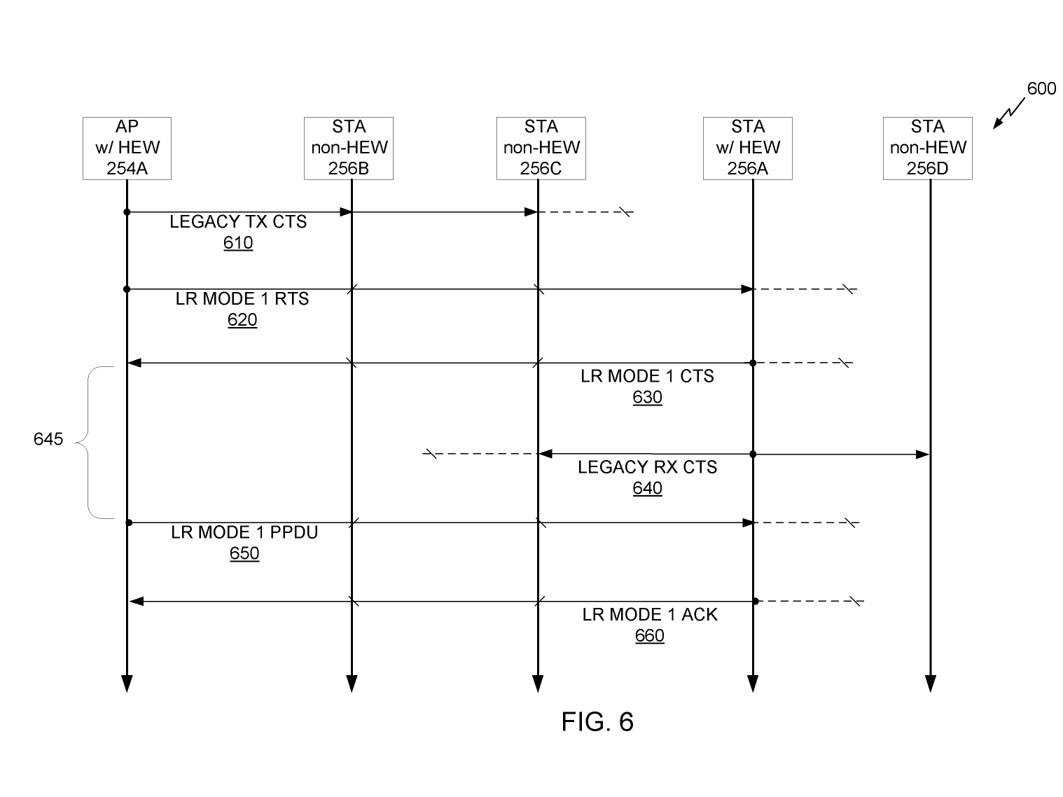

Because the legacy STA 256D does not receive the legacy CTS 510, it may potentially interfere with reception of the LR PPDU 520 by the HEW STA 256A. In an embodiment, the HEW STA 256A can also transmit a legacy CTS as described below with respect to FIG. 6.

FIG. 6 is another timing diagram 600 showing various communications in the wireless communication system 250 of FIG. 3, according to an embodiment. As shown in the timing diagram 600, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 600 refers to the device configuration shown in FIG. 3, other configurations are possible including omission of various devices shown or addition of other devices. For example, in various embodiments, the HEW AP 254A can be replaced with a HEW STA. Moreover, although the timing diagram 600 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 6, the HEW AP 254A transmits a legacy clear-to-send (CTS) frame 610. The legacy CTS frame 610 can be a CTS-to-self frame and can set a network allocation vector (NAV) at least partially protecting the following LR transmissions. Because the legacy CTS frame 610 is not an LR transmission, it may only be received by devices within the legacy association and deferral range 264A (FIG. 3). Thus, the legacy STAs 256B and 256C can receive the legacy CTS frame 610 while the HEW STA 256A and the legacy STA 256D may not. Accordingly, the legacy STAs 256B and 256C can defer to the following LR transmissions and can refrain from transmitting until the NAV expires.

Next, the HEW AP 254A transmits an LR ready-to-send (RTS) frame 620, which is received by the HEW STA 256A. In response to the LR RTS frame 620, the HEW STA 256A transmits an LR CTS 630, which can be received by the HEW AP 254A. In an embodiment, the LR CTS 630 can be omitted.

Thereafter, the HEW STA 256A transmits a legacy clear-to-send (CTS) frame 640. The legacy CTS frame 640 can be a CTS-to-self frame and can set a network allocation vector (NAV) at least partially protecting the following LR transmissions. Because the legacy CTS frame 640 is not an LR transmission, it may only be received by devices within the legacy range of the HEW STA 256A. Thus, the legacy STAs 256D and 256C can receive the legacy CTS frame 640 while the HEW AP 254A and the legacy STA 256B may not. Accordingly, the legacy STAs 256D and 256C can defer to the following LR transmissions and can refrain from transmitting until the NAV expires.

The HEW AP 254A can then wait for a predetermined (or dynamically determined) time 645 (e.g., for the legacy CTS to be transmitted). Then, the HEW AP 254A may transmit an LR physical layer convergence protocol data unit (PPDU) 650 to the HEW STA 256A. In embodiments where the LR CTS 630 is omitted, the time 645 can start at the end of the LR RTS 620 transmission. The illustrated LR PPDU 650 is a mode 1 LR transmission. Accordingly, legacy STAs, even those within range, do not receive the LR PPDU 650. The HEW STA 256A sends an LR ACK 660 to the HEW AP 254A to acknowledge receipt of the LR PPDU 650.

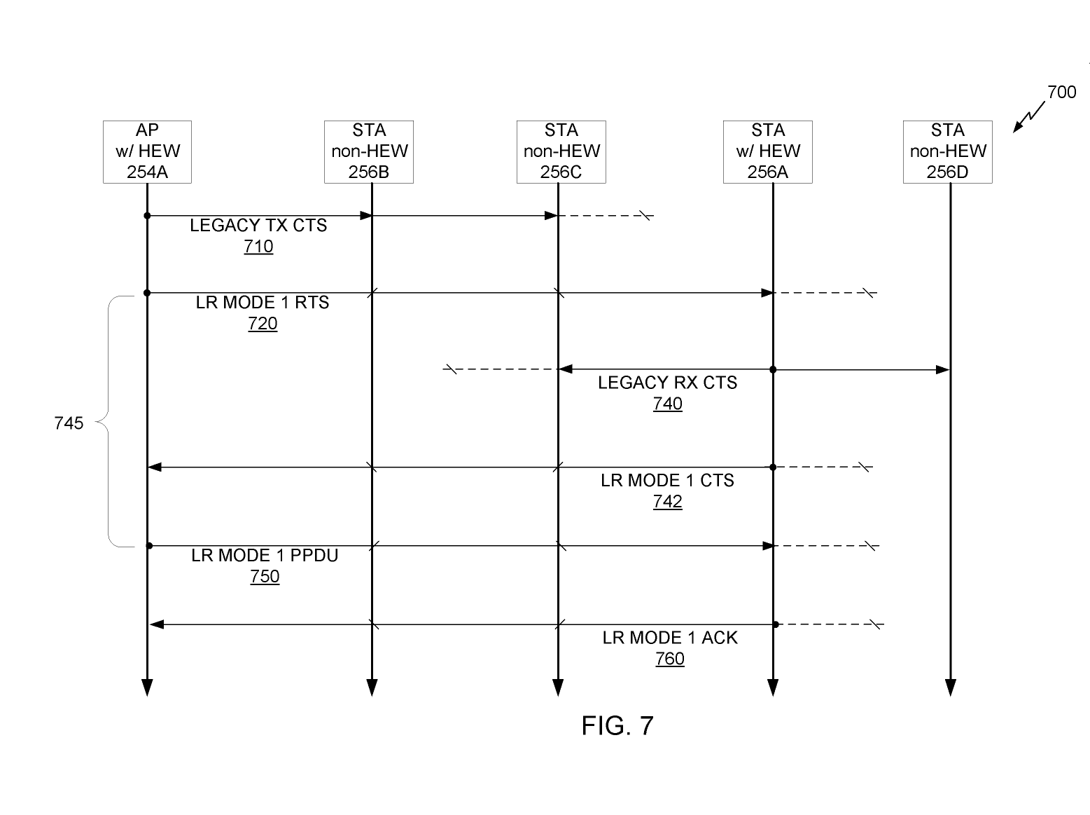

In an embodiment, the HEW STA 256A can refrain from transmitting the LR CTS 630 in response to the LR RTS 620, or the HEW STA 256A can transmit the LR CTS 630 after transmitting the legacy CTS 640. In one aspect, the HEW AP 254A may blindly proceed with data transmission, as described below with respect to FIG. 7.

FIG. 7 is another timing diagram 700 showing various communications in the wireless communication system 250 of FIG. 3, according to an embodiment. As shown in the timing diagram 700, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 700 refers to the device configuration shown in FIG. 3, other configurations are possible including omission of various devices shown or addition of other devices. For example, in various embodiments, the HEW AP 254A can be replaced with a HEW STA. Moreover, although the timing diagram 700 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 7, the HEW AP 254A transmits a legacy clear-to-send (CTS) frame 710. The legacy CTS frame 710 can be a CTS-to-self frame and can set a network allocation vector (NAV) at least partially protecting the following LR transmissions. Because the legacy CTS frame 710 is not an LR transmission, it may only be received by devices within the legacy association and deferral range 264A (FIG. 3). Thus, the legacy STAs 256B and 256C can receive the legacy CTS frame 710 while the HEW STA 256A and the legacy STA 256D may not. Accordingly, the legacy STAs 256B and 256C can defer to the following LR transmissions and can refrain from transmitting until the NAV expires.

Next, the HEW AP 254A transmits an LR ready-to-send (RTS) frame 720, which is received by the HEW STA 256A. The HEW STA 256A transmits a legacy clear-to-send (CTS) frame 740. The legacy CTS frame 740 can be a CTS-to-self frame and can set a network allocation vector (NAV) at least partially protecting the following LR transmissions. Because the legacy CTS frame 740 is not an LR transmission, it may only be received by devices within the legacy range of the HEW STA 256A. Thus, the legacy STAs 256D and 256C can receive the legacy CTS frame 740 while the HEW AP 254A and the legacy STA 256B may not. Accordingly, the legacy STAs 256D and 256C can defer to the following LR transmissions and can refrain from transmitting until the NAV expires. In some embodiments, the HEW STA 256A transmits an LR CTS 742, which can be received by the HEW AP 254A. In an embodiment, the LR CTS 742 can be omitted.

The HEW AP 254A can wait a predetermined (or dynamically determined) amount of time 745 after transmitting the LR RTS 720. For example, the HEW AP 254A can wait until receiving the LR CTS 742 or, in embodiments in which the LR CTS 742 is omitted, for a timeout period. After waiting the time 745, the HEW AP 254A transmits an LR physical layer convergence protocol data unit (PPDU) 750 to the HEW STA 256A. The illustrated LR PPDU 750 is a mode 1 LR transmission. Accordingly, legacy STAs, even those within range, do not receive the LR PPDU 750. The HEW STA 256A sends an LR ACK 760 to the HEW AP 254A to acknowledge receipt of the LR PPDU 750.

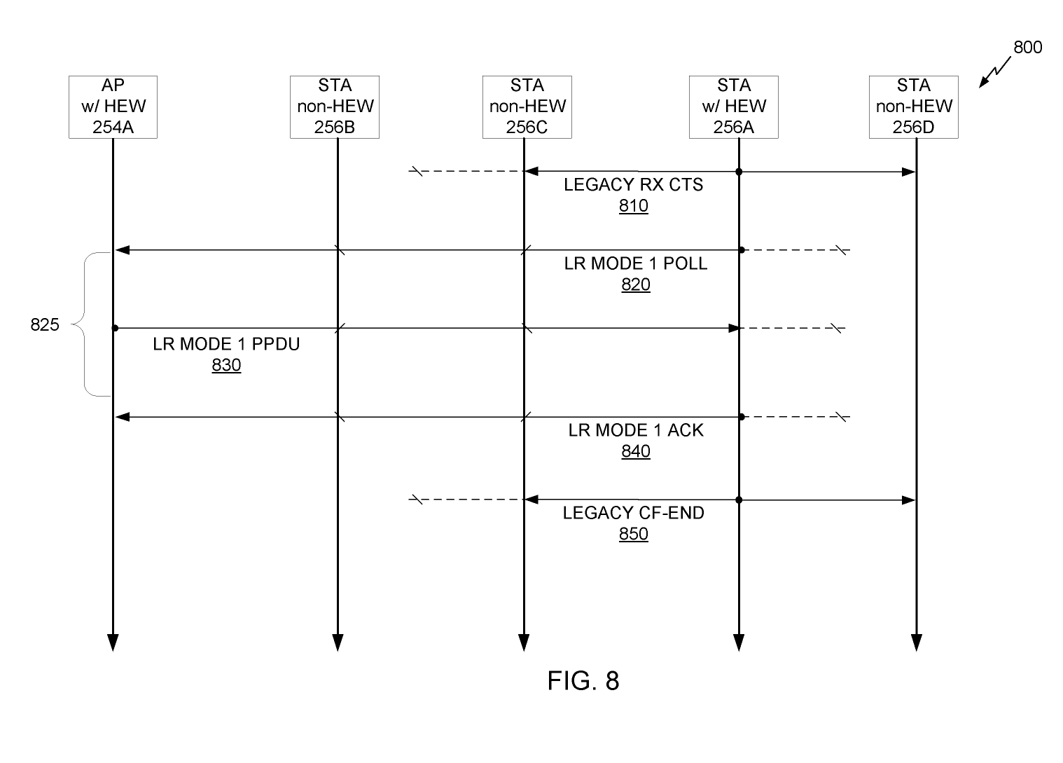

In various embodiments, the STAs 256A-256D can be configured to intermittently enter a power-saving mode. Accordingly, in some embodiments, the STAs 256A-256D may miss a transmission from the HEW AP 254A. In various embodiments described below with respect to FIGS. 8-11, the HEW STA 256A can poll the HEW AP 254A for data.

FIG. 8 is another timing diagram 800 showing various communications in the wireless communication system 250 of FIG. 3, according to an embodiment. As shown in the timing diagram 800, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 800 refers to the device configuration shown in FIG. 3, other configurations are possible including omission of various devices shown or addition of other devices. For example, in various embodiments, the HEW AP 254A can be replaced with a HEW STA. Moreover, although the timing diagram 800 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 8, the HEW STA 256A transmits a legacy clear-to-send (CTS) frame 810. The legacy CTS frame 810 can be a CTS-to-self frame and can set a network allocation vector (NAV) at least partially protecting the following LR transmissions. Because the legacy CTS frame 810 is not an LR transmission, it may only be received by devices within a local legacy range. Thus, the legacy STAs 256D and 256C can receive the legacy CTS frame 810 while the HEW AP 254A and the legacy STA 256B may not. Accordingly, the legacy STAs 256D and 256C can defer to the following LR transmissions and can refrain from transmitting until the NAV expires.

Next, the HEW STA 256A transmits an LR poll frame 820, which is received by the HEW AP 254A. The LR poll 820 can be, for example, a power save (PS) poll frame requesting available data from the HEW AP 254A. If the HEW AP 254A comprises data for the HEW STA 256A, it can determine whether to provide the data or refrain from providing the data. In some embodiments, the HEW AP 254A provides the data within a point coordination function interframe space (PIFS) 825 of receiving the LR poll 820.

Then, the HEW AP 254A transmits an LR physical layer convergence protocol data unit (PPDU) 830 to the HEW STA 256A. The illustrated LR PPDU 830 is a mode 1 LR transmission. Accordingly, legacy STAs, even those within range, do not receive the LR PPDU 830. The HEW STA 256A sends an LR ACK 840 to the HEW AP 254A to acknowledge receipt of the LR PPDU 830.

In some embodiments, the HEW STA 256A can transmit a legacy control frame (CF)-end 850 after transmitting the LR ACK 840. The CF-end 850 can terminate the NAV set by the legacy CTS 810. Accordingly, the legacy STAs 256C and 256D can transmit thereafter.

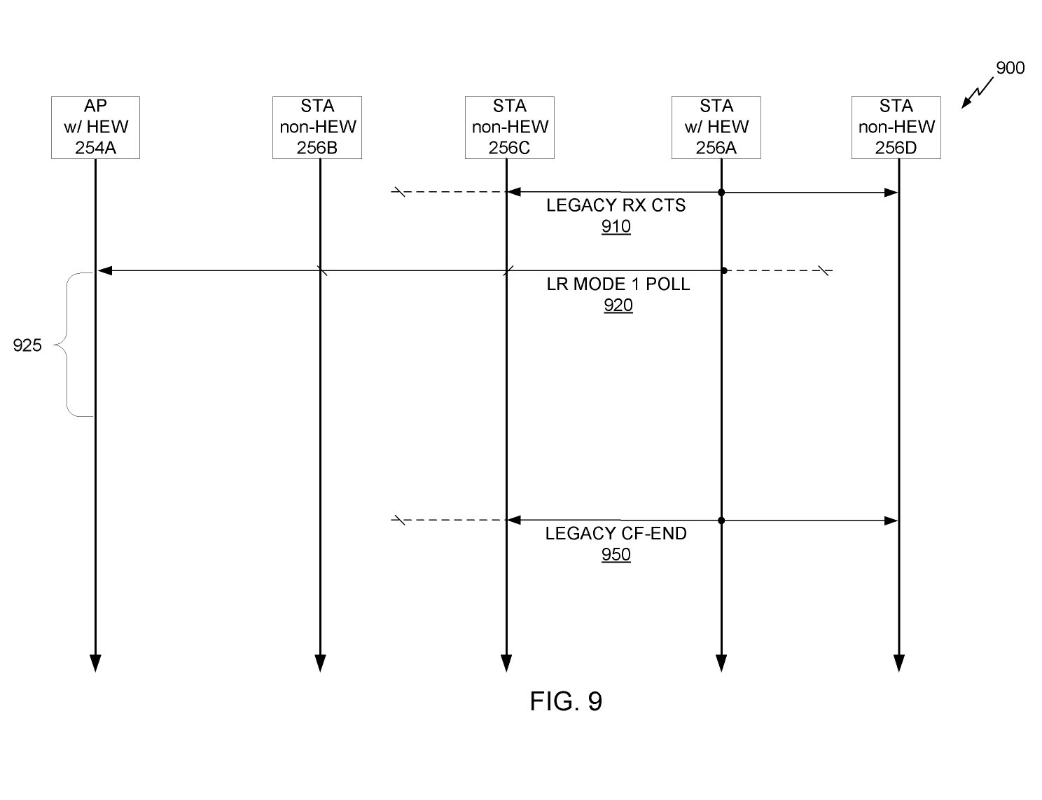

In various embodiments, the HEW AP 254A may not respond to the LR poll 820 with data. For example, the HEW AP 254A may not receive the LR poll 820. As another example, the HEW AP 254A may not have any data for the HEW STA 256A. As another example, the HEW AP 254A may refrain from transmitting data for another reason, such as a lack of available time slots. FIG. 9 illustrates an embodiment wherein the HEW AP 254A does not respond to an LR poll.

FIG. 9 is another timing diagram 900 showing various communications in the wireless communication system 250 of FIG. 3, according to an embodiment. As shown in the timing diagram 900, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 900 refers to the device configuration shown in FIG. 3, other configurations are possible including omission of various devices shown or addition of other devices. For example, in various embodiments, the HEW AP 254A can be replaced with a HEW STA. Moreover, although the timing diagram 900 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 9, the HEW STA 256A transmits a legacy clear-to-send (CTS) frame 910. The legacy CTS frame 910 can be a CTS-to-self frame and can set a network allocation vector (NAV) at least partially protecting the following LR transmissions. Because the legacy CTS frame 910 is not an LR transmission, it may only be received by devices within a local legacy range. Thus, the legacy STAs 256D and 256C can receive the legacy CTS frame 910 while the HEW AP 254A and the legacy STA 256B may not. Accordingly, the legacy STAs 256D and 256C can defer to the following LR transmissions and can refrain from transmitting until the NAV expires.

Next, the HEW STA 256A transmits an LR poll frame 920, which is received by the HEW AP 254A. In other embodiments, the LR poll frame 920 is not received by the HEW AP 254A. The LR poll 920 can be, for example, a power save (PS) poll frame requesting available data from the HEW AP 254A. If the HEW AP 254A comprises data for the HEW STA 256A, it can determine whether to provide the data or refrain from providing the data.

In some embodiments, the HEW STA 256A waits a point coordination function interframe space (PIFS) 925, after transmitting the LR poll 920, for the HEW AP 254A to provide data. If the HEW AP 254A does not provide data within the PIFS 925, the HEW STA 256A can transmit a legacy control frame (CF)-end 950. The CF-end 950 can terminate the NAV set by the legacy CTS 910. Accordingly, the legacy STAs 256C and 256D can transmit thereafter.

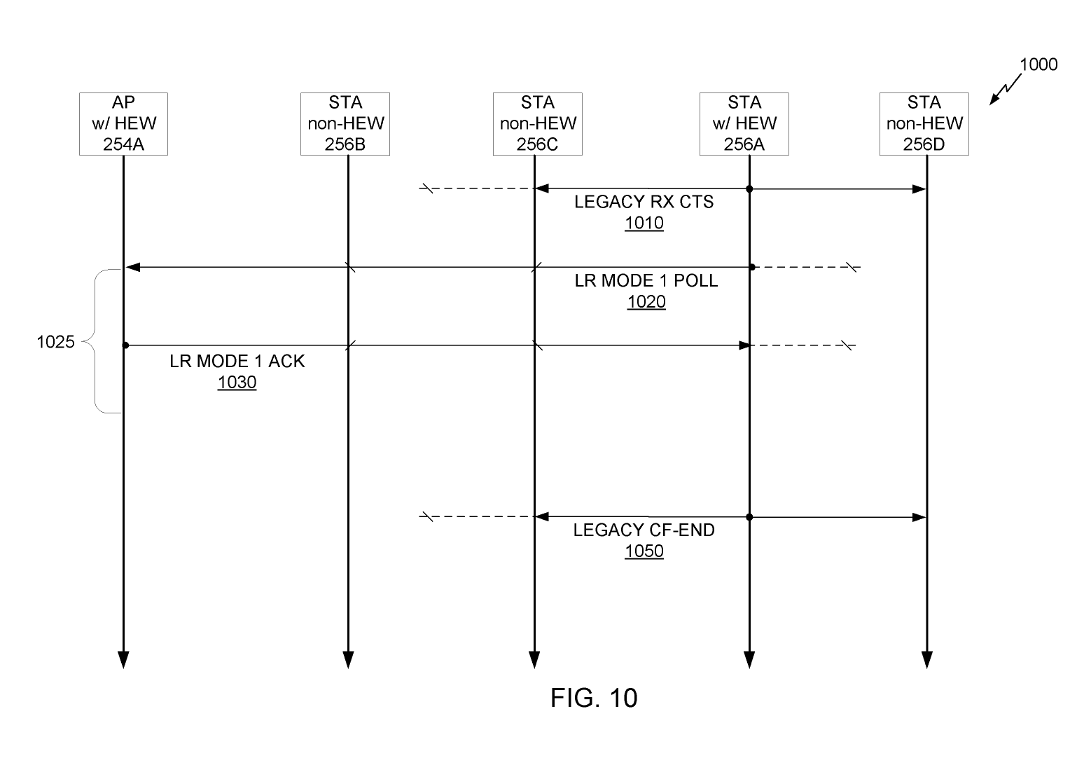

In various embodiments, the HEW AP 254A may respond to the LR poll 920 with an acknowledgment. For example, the HEW AP 254A may receive the LR poll 920, but may refrain from transmitting data for another reason, such as a lack of available time slots. FIG. 10 illustrates an embodiment wherein the HEW AP 254A responds to an LR poll with an ACK.

FIG. 10 is another timing diagram 1000 showing various communications in the wireless communication system 250 of FIG. 3, according to an embodiment. As shown in the timing diagram 1000, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1000 refers to the device configuration shown in FIG. 3, other configurations are possible including omission of various devices shown or addition of other devices. For example, in various embodiments, the HEW AP 254A can be replaced with a HEW STA. Moreover, although the timing diagram 1000 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 10, the HEW STA 256A transmits a legacy clear-to-send (CTS) frame 1010. The legacy CTS frame 1010 can be a CTS-to-self frame and can set a network allocation vector (NAV) at least partially protecting the following LR transmissions. Because the legacy CTS frame 1010 is not an LR transmission, it may only be received by devices within a local legacy range. Thus, the legacy STAs 256D and 256C can receive the legacy CTS frame 1010 while the HEW AP 254A and the legacy STA 256B may not. Accordingly, the legacy STAs 256D and 256C can defer to the following LR transmissions and can refrain from transmitting until the NAV expires.

Next, the HEW STA 256A transmits an LR poll frame 1020, which is received by the HEW AP 254A. The LR poll 1020 can be, for example, a power save (PS) poll frame requesting available data from the HEW AP 254A. If the HEW AP 254A comprises data for the HEW STA 256A, it can determine whether to provide the data or refrain from providing the data. In some embodiments, the HEW AP 254A provides an acknowledgement within a point coordination function interframe space (PIFS) 1025 of receiving the LR poll 1020, when it does not provide data.

Then, the HEW AP 254A transmits an LR ACK 1030 to the HEW STA 256A. The illustrated LR ACK 1030 is a mode 1 LR transmission. Accordingly, legacy STAs, even those within range, do not receive the LR PPDU 1030.

In some embodiments, the HEW STA 256A can transmit a legacy control frame (CF)-end 1050 after receiving the LR ACK 1030. The CF-end 1050 can terminate the NAV set by the legacy CTS 1010. Accordingly, the legacy STAs 256C and 256D can transmit thereafter.

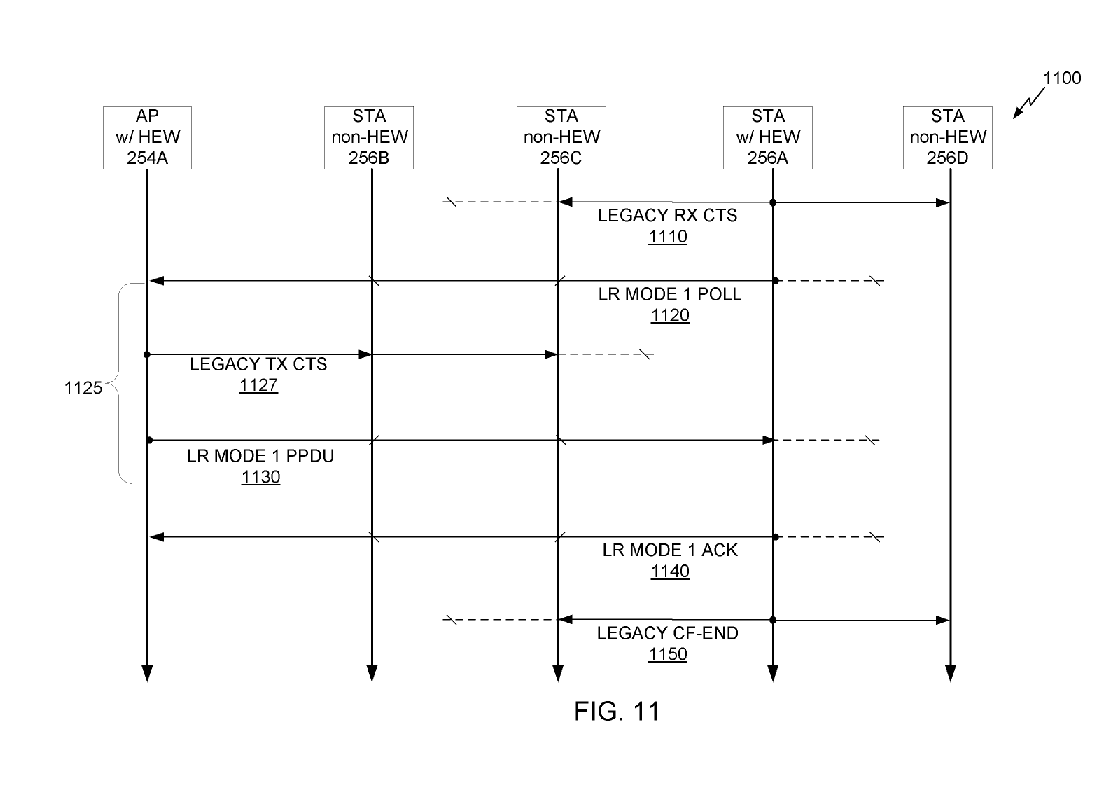

In various embodiments, the HEW AP 254A can further protect its response to the LR poll 1020. For example, an unprotected acknowledgement or data transmission can experience interference from nearby legacy STAs. FIG. 11 illustrates an embodiment wherein the HEW AP 254A sets a legacy NAV prior to responding to an LR poll.

FIG. 11 is another timing diagram 1100 showing various communications in the wireless communication system 250 of FIG. 3, according to an embodiment. As shown in the timing diagram 1100, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1100 refers to the device configuration shown in FIG. 3, other configurations are possible including omission of various devices shown or addition of other devices. For example, in various embodiments, the HEW AP 254A can be replaced with a HEW STA. Moreover, although the timing diagram 1100 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 11, the HEW STA 256A transmits a legacy clear-to-send (CTS) frame 1110. The legacy CTS frame 1110 can be a CTS-to-self frame and can set a network allocation vector (NAV) at least partially protecting the following LR transmissions. Because the legacy CTS frame 1110 is not an LR transmission, it may only be received by devices within a local legacy range. Thus, the legacy STAs 256D and 256C can receive the legacy CTS frame 1110 while the HEW AP 254A and the legacy STA 256B may not. Accordingly, the legacy STAs 256D and 256C can defer to the following LR transmissions and can refrain from transmitting until the NAV expires.

Next, the HEW STA 256A transmits an LR poll frame 1120, which is received by the HEW AP 254A. The LR poll 1120 can be, for example, a power save (PS) poll frame requesting available data from the HEW AP 254A. If the HEW AP 254A comprises data for the HEW STA 256A, it can determine whether to provide the data or refrain from providing the data. In some embodiments, the HEW AP 254A provides the data within a point coordination function interframe space (PIFS) 1125 of receiving the LR poll 1120.

Then, the HEW AP 254A transmits a legacy CTS frame 1127. The legacy CTS 1127 can be a CTS-to-self frame and can set a network allocation vector (NAV) at least partially protecting the following LR transmissions. Because the legacy CTS frame 1127 is not an LR transmission, it may only be received by devices within the legacy association and deferral range 264A (FIG. 3). Thus, the legacy STAs 256B and 256C can receive the legacy CTS frame 1127 while the HEW STA 256A and the legacy STA 256D may not. Accordingly, the legacy STAs 256B and 256C can defer to the following LR transmissions and can refrain from transmitting until the NAV expires.

Then, the HEW AP 254A transmits an LR physical layer convergence protocol data unit (PPDU) 1130 to the HEW STA 256A. The illustrated LR PPDU 1130 is a mode 1 LR transmission. Accordingly, legacy STAs, even those within range, do not receive the LR PPDU 1130. The HEW STA 256A sends an LR ACK 1140 to the HEW AP 254A to acknowledge receipt of the LR PPDU 1130.

In some embodiments, the HEW STA 256A can transmit a legacy control frame (CF)-end 1150 after transmitting the LR ACK 1140. The CF-end 1150 can terminate the NAV set by the legacy CTS 1110. Accordingly, the legacy STAs 256C and 256D can transmit thereafter.

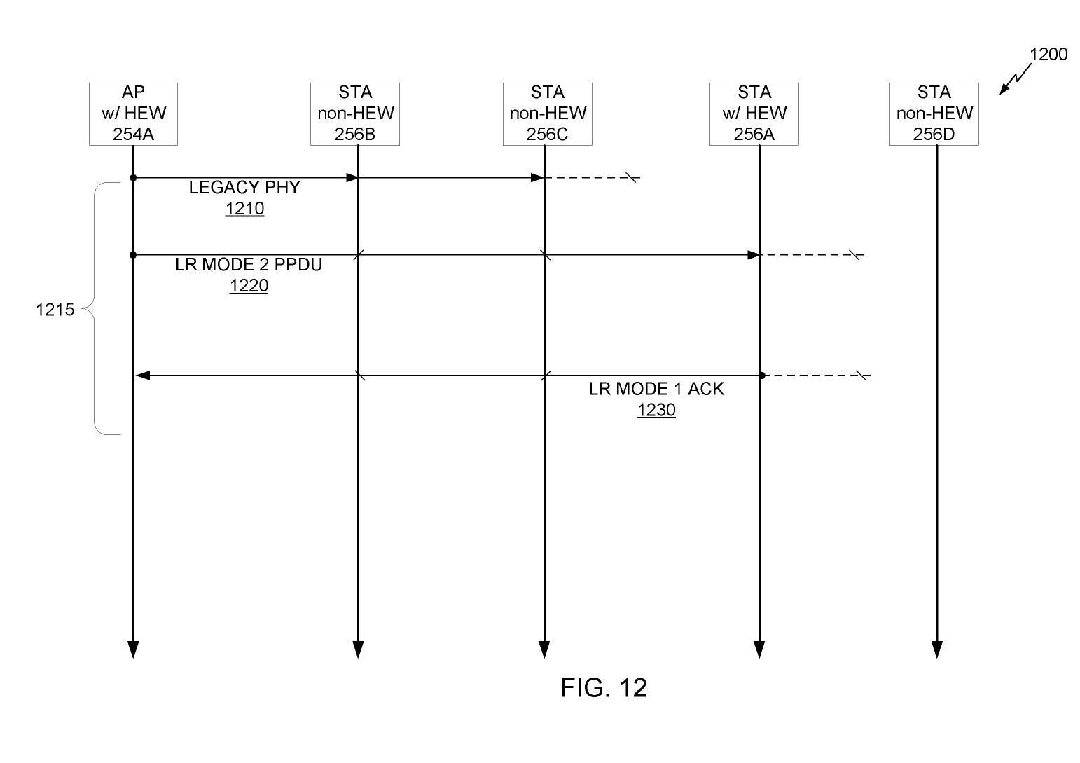

In various embodiments, the approaches described above with respect to FIGS. 5-11 can be used with LR mode 2 transmissions instead of LR mode 1 transmissions. In general, CTS frames can be replaced with a portion of a transmission available to legacy STAs for deferral (for example, a legacy portion of a preamble for LR data). FIGS. 12-17 illustrate various embodiments for at least partially protecting LR mode 2 transmissions.

### Protection for Mode 2

FIG. 12 is a timing diagram 1200 showing various communications in the wireless communication system 250 of FIG. 3, according to an embodiment. As shown in the timing diagram 1200, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1200 refers to the device configuration shown in FIG. 3, other configurations are possible including omission of various devices shown or addition of other devices. For example, in various embodiments, the HEW AP 254A can be replaced with a HEW STA. Moreover, although the timing diagram 1200 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 12, the HEW AP 254A transmits a frame including a legacy physical (PHY) preamble 1210. The legacy PHY 1210 can include a spoofed duration 1215 (e.g., longer than otherwise appropriate for the frame) indicating that other STAs may defer to the following LR transmissions. Because the legacy PHY 1210 is not an LR transmission, it may only be received by devices within the legacy association and deferral range 264A (FIG. 3). Thus, the legacy STAs 256B and 256C can receive the legacy PHY 1210 while the HEW STA 256A and the legacy STA 256D may not. Accordingly, the legacy STAs 256B and 256C can defer to the following LR transmissions and can refrain from transmitting for the spoofed duration 1215 indicated. In some embodiments, the legacy portion (e.g., the legacy PHY) may be transmitted at a higher power such that it may comprise a longer range.

Next, the HEW AP 254A transmits an LR physical layer convergence protocol data unit (PPDU) 1220 to the HEW STA 256A. The PPDU 1220 and the legacy PHY 1210 can be separate portions of the same frame. The illustrated LR PPDU 1220 is a mode 2 LR transmission. Accordingly, legacy STAs, even those within range, do not receive the LR PPDU 1220. The HEW STA 256A sends an LR ACK 1230 to the HEW AP 254A to acknowledge receipt of the LR PPDU 1220. In the illustrated embodiment, the LR ACK 1230 is a mode 1 LR transmission, although it can also be a mode 2 LR transmission.

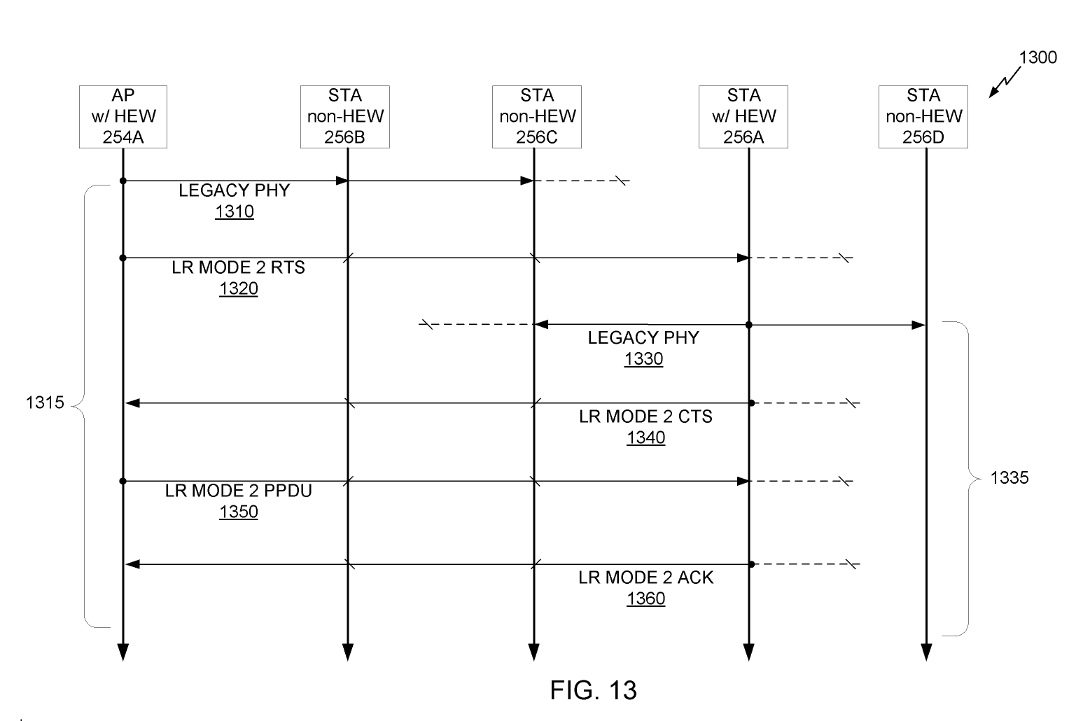

Because the legacy STA 256D does not receive the legacy PHY 1210, it may potentially interfere with reception of the LR PPDU 1220 by the HEW STA 256A. In an embodiment, the HEW STA 256A can also transmit a legacy PHY as described below with respect to FIG. 13.

FIG. 13 is another timing diagram 1300 showing various communications in the wireless communication system 250 of FIG. 3, according to an embodiment. As shown in the timing diagram 1300, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1300 refers to the device configuration shown in FIG. 3, other configurations are possible including omission of various devices shown or addition of other devices. For example, in various embodiments, the HEW AP 254A can be replaced with a HEW STA. Moreover, although the timing diagram 1300 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 13, the HEW AP 254A transmits a frame including a legacy physical (PHY) preamble 1310. The legacy PHY 1310 can include a spoofed duration 1315 (e.g., longer than otherwise appropriate for the frame) indicating that other STAs may defer to the following LR transmissions. Because the legacy PHY 1310 is not an LR transmission, it may only be received by devices within the legacy association and deferral range 264A (FIG. 3). Thus, the legacy STAs 256B and 256C can receive the legacy PHY 1310 while the HEW STA 256A and the legacy STA 256D may not. Accordingly, the legacy STAs 256B and 256C can defer to the following LR transmissions and can refrain from transmitting for the spoofed duration 1315 indicated. In some embodiments, the legacy portion (e.g., the legacy PHY) may be transmitted at a higher power such that it may comprise a longer range.

Next, the HEW AP 254A transmits an LR ready-to-send (RTS) frame 1320, which is received by the HEW STA 256A. The RTS 1320 and the legacy PHY 1310 can be two portions of the same frame. In response to the LR RTS frame 1320, the HEW AP 254A can transmit a legacy PHY 1330 for an LR CTS frame 1340. The legacy PHY 1330 can include a spoofed duration 1335 (e.g., longer than otherwise appropriate for the frame) indicating that other STAs may defer to the following LR transmissions. Because the legacy PHY 1330 is not an LR transmission, it may only be received by devices within the legacy range of the HEW STA 256A. Thus, the legacy STAs 256D and 256C can receive the legacy PHY 1330 while the HEW AP 254A and the legacy STA 256B may not. Accordingly, the legacy STAs 256D and 256C can defer to the following LR transmissions and can refrain from transmitting for the spoofed duration 1335 indicated. In some embodiments, the legacy portion (e.g., the legacy PHY) may be transmitted at a higher power such that it may comprise a longer range.

Then, the HEW STA 256A transmits an LR CTS 1340, which can be received by the HEW AP 254A. The LR CTS 1330 and the legacy PHY 1330 can be two portions of the same frame. In response, the HEW AP 254A transmits an LR physical layer convergence protocol data unit (PPDU) 1350 to the HEW STA 256A. The illustrated LR PPDU 1350 is a mode 2 LR transmission, although in various embodiments it can be a mode 1 LR transmission including a legacy PHY. Accordingly, legacy STAs, even those within range, do not receive the LR PPDU 1350. The HEW STA 256A sends an LR ACK 1360 to the HEW AP 254A to acknowledge receipt of the LR PPDU 1350.

In some embodiments, the HEW AP 254A may not be configured to detect the legacy portion 1330 of the LR CTS 1340 sent by the HEW STA 256A. Thus, in some embodiments, the HEW AP 254A can wait for a predetermined (or dynamically determined) amount of time to see if it detects the LR portion 1340. In an embodiment, the waiting time can be a short interframe space (SIFS), plus a duration of a legacy preamble (e.g., the legacy PHY 1330).

In some embodiments, the HEW AP 254A may not receive the LR CTS 1340. The HEW AP 254A can wait a predetermined (or dynamically determined) amount of time after transmitting the LR RTS 1320. After waiting the time, the HEW AP 254A transmits an LR physical layer convergence protocol data unit (PPDU) 1350 to the HEW STA 256A.

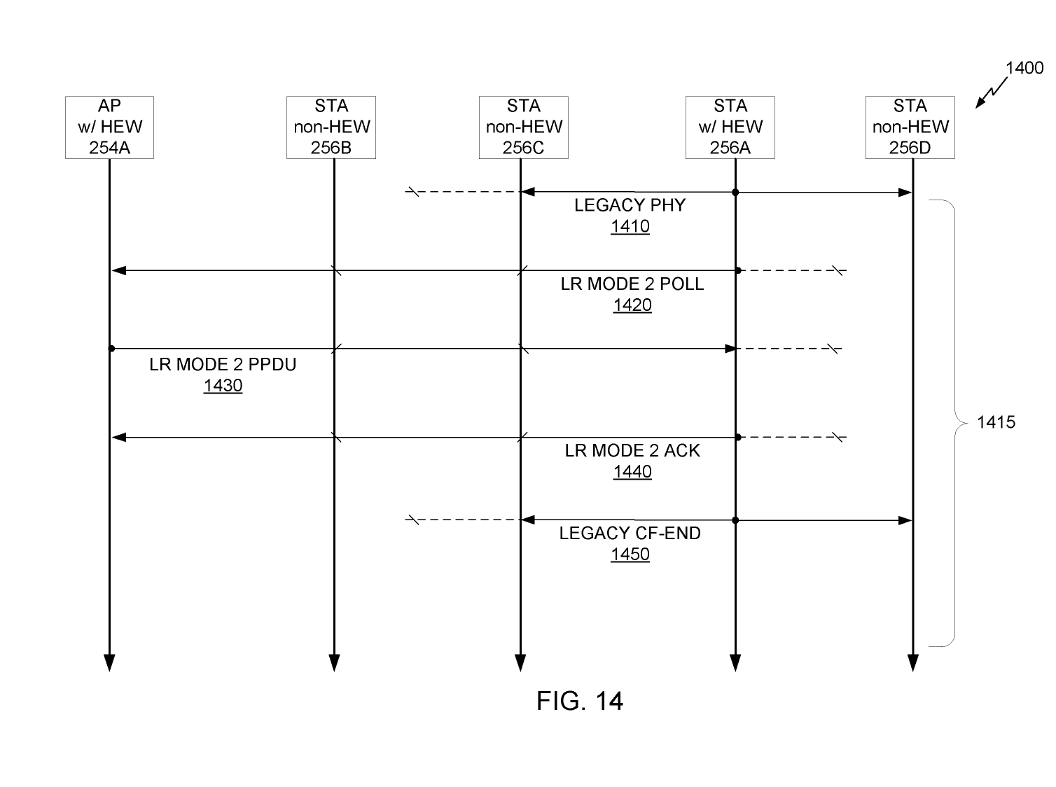

In an embodiment, the HEW STA 256A can refrain from transmitting the LR CTS 1330 in response to the LR RTS 1320, or the HEW STA 256A can transmit the LR CTS 1330 after transmitting the legacy PHY 1340. In various embodiments, the STAs 256A-256D can be configured to intermittently enter a power-saving mode. Accordingly, in some embodiments, the STAs 256A-256D may miss a transmission from the AP 254A. In various embodiments described below with respect to FIGS. 14-16, the HEW STA 256A can poll the HEW AP 254A for data.

FIG. 14 is another timing diagram 1400 showing various communications in the wireless communication system 250 of FIG. 3, according to an embodiment. As shown in the timing diagram 1400, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1400 refers to the device configuration shown in FIG. 3, other configurations are possible including omission of various devices shown or addition of other devices. For example, in various embodiments, the HEW AP 254A can be replaced with a HEW STA. Moreover, although the timing diagram 1400 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 14, the HEW STA 256A transmits a frame including a legacy physical (PHY) preamble 1410. The legacy PHY 1410 can include a spoofed duration 1415 (e.g., longer than otherwise appropriate for the frame) indicating that other STAs may defer to the following LR transmissions. Because the legacy PHY 1410 is not an LR transmission, it may only be received by devices within a local legacy range. Thus, the legacy STAs 256D and 256C can receive the legacy PHY 1410 while the HEW AP 254A and the legacy STA 256B may not. Accordingly, the legacy STAs 256D and 256C can defer to the following LR transmissions and can refrain from transmitting for the spoofed duration indicated. In some embodiments, the legacy portion (e.g., the legacy PHY) may be transmitted at a higher power such that it may comprise a longer range.

Next, the HEW STA 256A transmits an LR poll frame 1420, which is received by the HEW AP 254A. The LR poll 1420 and the legacy PHY 1410 can be two portions of the same frame. The LR poll 1420 can be, for example, a power save (PS) poll frame requesting available data from the HEW AP 254A. If the HEW AP 254A comprises data for the HEW STA 256A, it can determine whether to provide the data or refrain from providing the data. In some embodiments, the HEW AP 254A provides the data within a point coordination function interframe space (PIFS) 1425 of receiving the LR poll 1420.

Then, the HEW AP 254A transmits an LR physical layer convergence protocol data unit (PPDU) 1430 to the HEW STA 256A. The illustrated LR PPDU 1430 is a mode 2 LR transmission, although in various embodiments it can be a mode 1 LR transmission including a legacy PHY. Accordingly, legacy STAs, even those within range, do not receive the LR PPDU 1430. The HEW STA 256A sends an LR ACK 1440 to the HEW AP 254A to acknowledge receipt of the LR PPDU 1430.

In some embodiments, the HEW STA 256A can transmit a legacy control frame (CF)-end 1450 after transmitting the LR ACK 1440. The CF-end 1450 can terminate the NAV set by the legacy PHY 1410. Accordingly, the legacy STAs 256C and 256D can transmit thereafter.

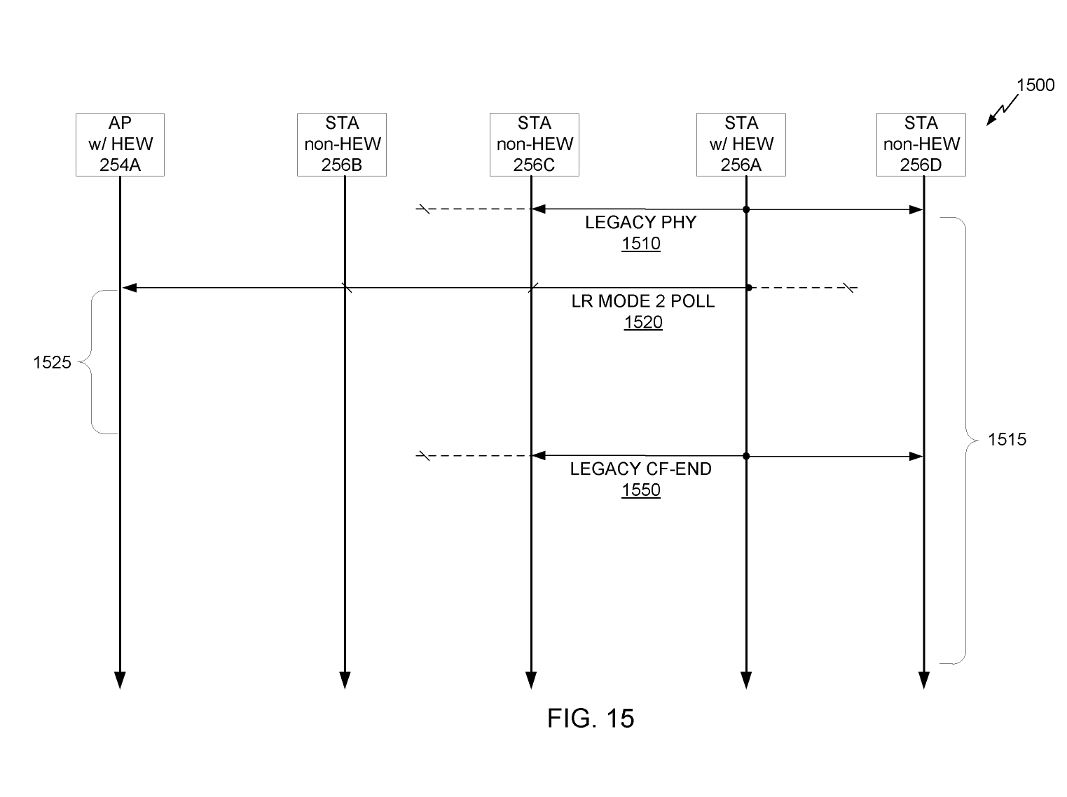

In various embodiments, the HEW AP 254A may not respond to the LR poll 1420 with data. For example, the HEW AP 254A may not receive the LR poll 1420. As another example, the HEW AP 254A may not have any data for the HEW STA 256A. As another example, the HEW AP 254A may refrain from transmitting data for another reason, such as a lack of available time slots. FIG. 15 illustrates an embodiment wherein the HEW AP 254A does not respond to an LR poll.

FIG. 15 is another timing diagram 1500 showing various communications in the wireless communication system 250 of FIG. 3, according to an embodiment. As shown in the timing diagram 1500, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1500 refers to the device configuration shown in FIG. 3, other configurations are possible including omission of various devices shown or addition of other devices. For example, in various embodiments, the HEW AP 254A can be replaced with a HEW STA. Moreover, although the timing diagram 1500 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 15, the HEW STA 256A transmits a frame including a legacy physical (PHY) preamble 1510. The legacy PHY 1510 can include a spoofed duration 1515 (e.g., longer than otherwise appropriate for the frame) indicating that other STAs may defer to the following LR transmissions. Because the legacy PHY 1510 is not an LR transmission, it may only be received by devices within a local legacy range. Thus, the legacy STAs 256D and 256C can receive the legacy PHY 1510 while the HEW AP 254A and the legacy STA 256B may not. Accordingly, the legacy STAs 256D and 256C can defer to the following LR transmissions and can refrain from transmitting for the spoofed duration 1515 indicated. In some embodiments, the legacy portion (e.g., the legacy PHY) may be transmitted at a higher power such that it may comprise a longer range.

Next, the HEW STA 256A transmits an LR poll frame 1520, which is received by the HEW AP 254A. The LR poll 1520 and the legacy PHY 1510 can be two portions of the same frame. In other embodiments, the LR poll frame 1520 is not received by the HEW AP 254A. The LR poll 1520 can be, for example, a power save (PS) poll frame requesting available data from the HEW AP 254A. If the HEW AP 254A comprises data for the HEW STA 256A, it can determine whether to provide the data or refrain from providing the data.

In some embodiments, the HEW STA 256A waits a point coordination function interframe space (PIFS) 1525, after transmitting the LR poll 1520, for the HEW AP 254A to provide data. If the HEW AP 254A does not provide data within the PIFS 1525, the HEW STA 256A can transmit a legacy control frame (CF)-end 1550. The CF-end 1550 can terminate the NAV set by the legacy PHY 1510. Accordingly, the legacy STAs 256C and 256D can transmit thereafter.

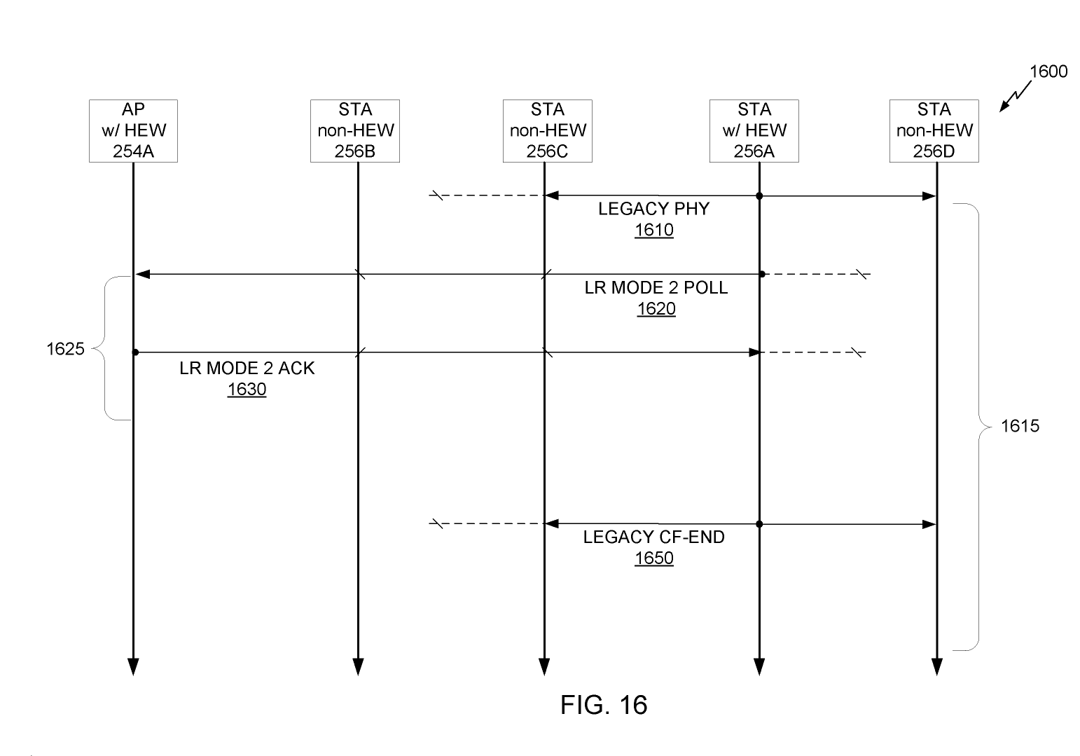

In various embodiments, the HEW AP 254A may respond to the LR poll 1520 with an acknowledgment. For example, the HEW AP 254A may receive the LR poll 1520, but may refrain from transmitting data for another reason, such as a lack of available time slots. FIG. 16 illustrates an embodiment wherein the HEW AP 254A responds to an LR poll with an ACK.

FIG. 16 is another timing diagram 1600 showing various communications in the wireless communication system 250 of FIG. 3, according to an embodiment. As shown in the timing diagram 1600, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1600 refers to the device configuration shown in FIG. 3, other configurations are possible including omission of various devices shown or addition of other devices. For example, in various embodiments, the HEW AP 254A can be replaced with a HEW STA. Moreover, although the timing diagram 1600 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 16, the HEW STA 256A transmits a frame including a legacy physical (PHY) preamble 1610. The legacy PHY 1610 can include a spoofed duration 1615 (e.g., longer than otherwise appropriate for the frame) indicating that other STAs may defer to the following LR transmissions. Because the legacy PHY 1610 is not an LR transmission, it may only be received by devices within a local legacy range. Thus, the legacy STAs 256D and 256C can receive the legacy PHY 1610 while the HEW AP 254A and the legacy STA 256B may not. Accordingly, the legacy STAs 256D and 256C can defer to the following LR transmissions and can refrain from transmitting for the spoofed duration 1615 indicated. In some embodiments, the legacy portion (e.g., the legacy PHY) may be transmitted at a higher power such that it may comprise a longer range.

Next, the HEW STA 256A transmits an LR poll frame 1620, which is received by the HEW AP 254A. The LR poll 1620 and the legacy PHY 1610 can be two portions of the same frame. The LR poll 1620 can be, for example, a power save (PS) poll frame requesting available data from the HEW AP 254A. If the HEW AP 254A comprises data for the HEW STA 256A, it can determine whether to provide the data or refrain from providing the data. In some embodiments, the HEW AP 254A provides an acknowledgement within a point coordination function interframe space (PIFS) 1625 of receiving the LR poll 1620, when it does not provide data.

Then, the HEW AP 254A transmits an LR ACK 1630 to the HEW STA 256A. The illustrated LR ACK 1630 is a mode 2 LR transmission, although in various embodiments it can be a mode 1 LR transmission including a legacy PHY. Accordingly, legacy STAs, even those within range, do not receive the LR PPDU 1630.

In some embodiments, the HEW STA 256A can transmit a legacy control frame (CF)-end 1650 after receiving the LR ACK 1630. The CF-end 1650 can terminate the NAV set by the legacy PHY 1610. Accordingly, the legacy STAs 256C and 256D can transmit thereafter.

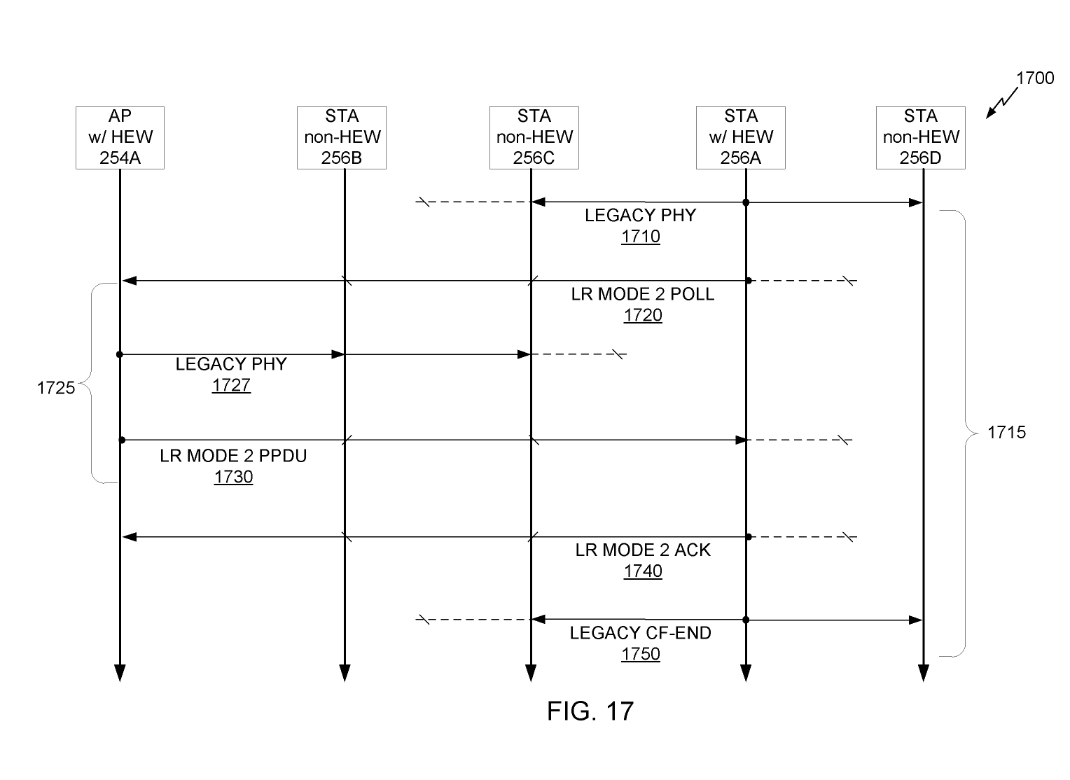

In various embodiments, the HEW AP 254A can further protect its response to the LR poll 1620. For example, an unprotected acknowledgement or data transmission can experience interference from nearby legacy STAs. FIG. 17 illustrates an embodiment wherein the HEW AP 254A sets a legacy NAV prior to responding to an LR poll.

FIG. 17 is another timing diagram 1700 showing various communications in the wireless communication system 250 of FIG. 3, according to an embodiment. As shown in the timing diagram 1700, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1700 refers to the device configuration shown in FIG. 3, other configurations are possible including omission of various devices shown or addition of other devices. For example, in various embodiments, the HEW AP 254A can be replaced with a HEW STA. Moreover, although the timing diagram 1700 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 17, the HEW STA 256A transmits a frame including a legacy physical (PHY) preamble 1710. The legacy PHY 1710 can include a spoofed duration 1715 (e.g., longer than otherwise appropriate for the frame) indicating that other STAs may defer to the following LR transmissions. Because the legacy PHY 1710 is not an LR transmission, it may only be received by devices within a local legacy range. Thus, the legacy STAs 256D and 256C can receive the legacy PHY 1710 while the HEW AP 254A and the legacy STA 256B may not. Accordingly, the legacy STAs 256D and 256C can defer to the following LR transmissions and can refrain from transmitting for the spoofed duration 1715 indicated. In some embodiments, the legacy portion (e.g., the legacy PHY) may be transmitted at a higher power such that it may comprise a longer range.

Next, the HEW STA 256A transmits an LR poll frame 1720, which is received by the HEW AP 254A. The LR poll 1720 can be, for example, a power save (PS) poll frame requesting available data from the HEW AP 254A. If the HEW AP 254A comprises data for the HEW STA 256A, it can determine whether to provide the data or refrain from providing the data. In some embodiments, the HEW AP 254A provides the data within a point coordination function interframe space (PIFS) 1725 of receiving the LR poll 1720.

Then, the HEW AP 254A transmits a legacy PHY 1727. The legacy PHY 1727 can include a spoofed duration (e.g., longer than otherwise appropriate for the frame) indicating that other STAs may defer to the following LR transmissions. Because the legacy PHY 1727 is not an LR transmission, it may only be received by devices within the legacy association and deferral range 264A (FIG. 3). Thus, the legacy STAs 256B and 256C can receive the legacy PHY 1727 while the HEW STA 256A and the legacy STA 256D may not. Accordingly, the legacy STAs 256B and 256C can defer to the following LR transmissions and can refrain from transmitting for the spoofed duration indicated. In some embodiments, the legacy portion (e.g., the legacy PHY) may be transmitted at a higher power such that it may comprise a longer range.

Then, the HEW AP 254A transmits an LR physical layer convergence protocol data unit (PPDU) 1730 to the HEW STA 256A. The illustrated LR PPDU 1730 is a mode 2 LR transmission, although in various embodiments it can be a mode 1 LR transmission including a legacy PHY. Accordingly, legacy STAs, even those within range, do not receive the LR PPDU 1730. The HEW STA 256A sends an LR ACK 1740 to the HEW AP 254A to acknowledge receipt of the LR PPDU 1730.

In some embodiments, the HEW STA 256A can transmit a legacy control frame (CF)-end 1750 after transmitting the LR ACK 1740. The CF-end 1750 can terminate the NAV set by the legacy PHY 1710. Accordingly, the legacy STAs 256C and 256D can transmit thereafter.

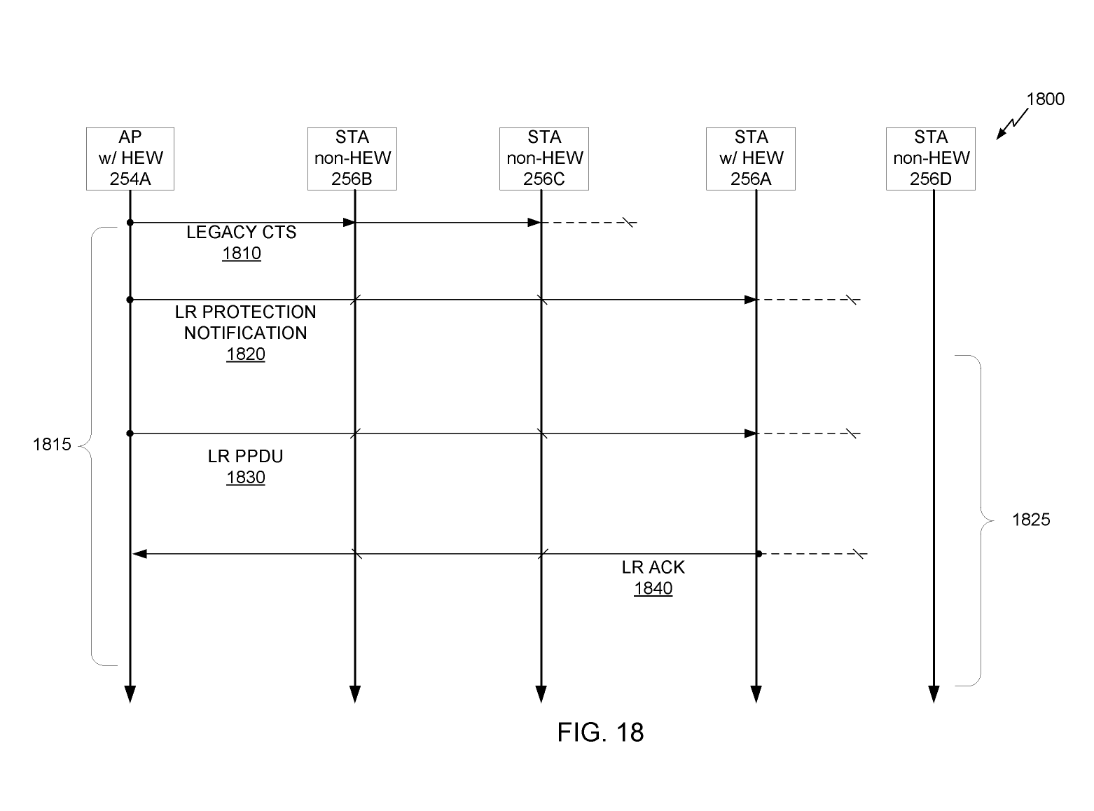

In various embodiments, the HEW AP 254A can at least partially protect LR transmissions by defining one or more protected time intervals reserved for LF transmissions (LF intervals). LF intervals are described below with respect to FIG. 18.

### Group Protection

FIG. 18 is a timing diagram 1800 showing various communications in the wireless communication system 250 of FIG. 3, according to an embodiment. As shown in the timing diagram 1800, communications between the HEW AP 254A, the HEW STA 256A, and the legacy STAs 256B-256D progress sequentially from top to bottom. Each communication is shown as a line originating from a transmitter (indicated with a dot) and being received by a receiver (indicated with an arrowhead). Communications that are not received are shown as a diagonal line through the communication. Although the timing diagram 1800 refers to the device configuration shown in FIG. 3, other configurations are possible including omission of various devices shown or addition of other devices. For example, in various embodiments, the HEW AP 254A can be replaced with a HEW STA. Moreover, although the timing diagram 1800 is described herein with reference to a particular order, in various embodiments, communications shown herein can be performed in a different order, or omitted, and additional communications can be added. For example, in various embodiments, one or more control frames can be added or omitted including acknowledgement (ACK) frames and/or end frames.

In FIG. 18, the HEW AP 254A transmits a legacy clear-to-send (CTS) frame 1810. The legacy CTS frame 1810 can be a CTS-to-self frame and can set a network allocation vector (NAV) 1815 at least partially protecting the following LR transmissions. Because the legacy CTS frame 1810 is not an LR transmission, it may only be received by devices within the legacy association and deferral range 264A (FIG. 3). Thus, the legacy STAs 256B and 256C can receive the legacy CTS frame 1810 while the HEW STA 256A and the legacy STA 256D may not. Accordingly, the legacy STAs 256B and 256C can defer to the following LR transmissions and can refrain from transmitting until the NAV 1815 expires.

Next, the HEW AP 254A transmits an LR protection notification (LRPN) frame 1820 to the HEW STA 256A. The illustrated LRPN 1820 is an LR transmission. Accordingly, legacy STAs, even those within range, do not receive the LR PPDU 1820. The LRPN frame 1820 defines an LR interval 1825 during which LR transmissions are protected by the NAV 1815 set in the legacy CTS 1810. In other words, the LRPN 1820 indicates when the HEW STA 256A can transmit and/or receive.

In various embodiments, the LRPN 1820 can include an indication that the LR interval 1825 is open, for the exclusive use of the transmitter of the LRPN 1820. In various embodiments, the LRPN 1820 can include an indication that the LR interval 1825 is open for any STA that wants to transmit LR communications, or for a preset or dynamically determined subset of HEW STAs. In various embodiments, the LRPN 1820 can indicate a schedule indicating which STAs can transmit and when (e.g., a reserved access window).

In some embodiments the LRPN 1825 can be substantially similar, or the same as a power-save multi poll (PSMP) frame (such as that defined in the IEEE 802.11n standard), or may include a restricted access window (RAW) indication (such as that defined in the IEEE 802.11ah standard).

In various embodiments, the HEW AP 254A and the HEW STA256A can exchange various LR communications within the LR interval 1825 such as, for example, the LR PPDU 1830 and the LR ACK 1840.

Because the legacy STA 256D does not receive the legacy CTS 1810, it may potentially interfere with reception of the LR PPDU 1820 by the HEW STA 256A. In an embodiment, the HEW STA 256A can also transmit a legacy CTS (not shown) setting a NAV similar to the NAV 1815.

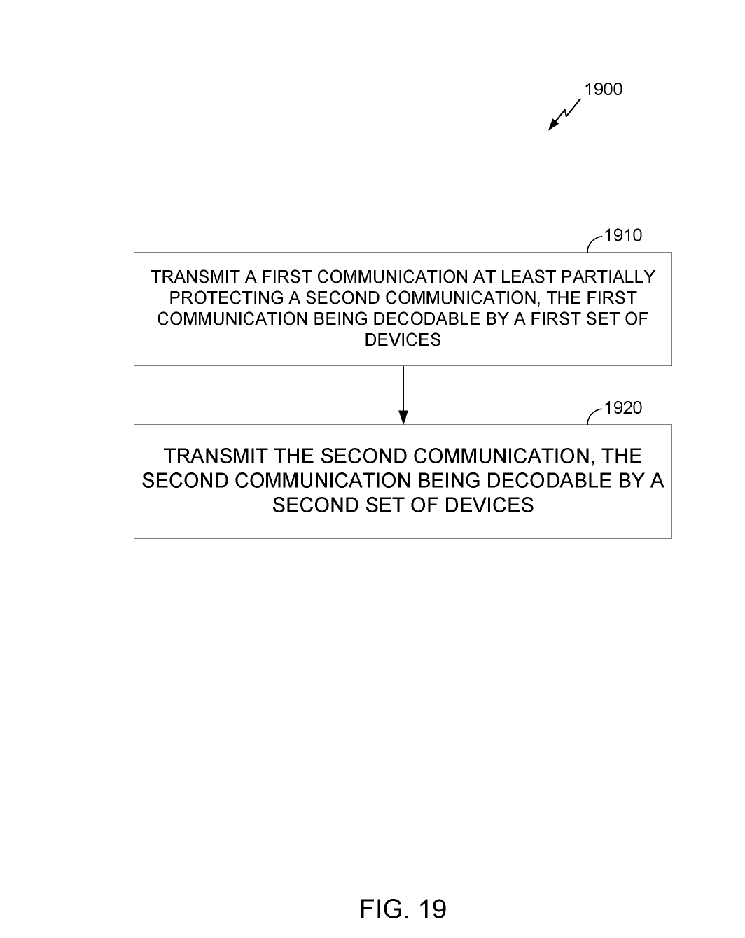

FIG. 19 is a flowchart 1900 of an exemplary method of wireless communication. Although the method of flowchart 1900 is described herein with reference to the wireless communication systems 100, 200, and 250 described above with respect to FIGS. 1-3 and the wireless device 402 described above with respect to FIG. 4, the method of flowchart 1900 can be implemented by another device described herein, any other suitable device, or any combination of multiple devices. In an embodiment, one or more steps in flowchart 1900 can be performed by a processor or controller such as, for example, the HEW controller 154 and/or 156A-156D (FIG. 1) and/or the HEW controller 424 (FIG. 4). Although the method of flowchart 1900 is described herein with reference to a particular order, in various embodiments, blocks herein can be performed in a different order, or omitted, and additional blocks can be added.

First, at block 1910, the wireless device 402 transmits a first communication at least partially protecting a second communication, the first communication being decodable by a first set of devices. For example, in various embodiments, the HEW AP 254A and/or the STA HEW 256A transmits one or more of the legacy CTS 510, 610, 640, 710, 740, 810, 910, 1010, 1110, and/or 1127 (FIGS. 5-12, respectively) and the legacy PHY 1210, 1310, 1330, 1410, 1510, 1610, 1710, and/or 1727 (FIGS. 12-17, respectively).

In various embodiments, the first communication can include a clear-to-send (CTS) frame. For example, the first communication can include one or more of the legacy CTS 510, 610, 640, 710, 740, 810, 910, 1010, 1110, and/or 1127 (FIGS. 5-12, respectively). The CTS frame can set a NAV protecting one or more subsequent LR transmissions.

In various embodiments, the first communication can include a portion of a preamble for the second communication. For example, the first communication can include one or more of the legacy PHY 1210, 1310, 1330, 1410, 1510, 1610, 1710, and/or 1727 (FIGS. 12-17, respectively). In various embodiments, the first communication can include a preamble indicating a duration longer than a duration of a frame containing the preamble. For example, the preamble can include one or more of the spoofed durations 1215, 1315, 1335, 1415, 1515, 1615, and/or 1715 (FIGS. 12-17, respectively).

Next, at block 1920, the wireless device 402 transmits the second communication, the second communication being decodable by a second set of devices. In various embodiments, the second communication includes a PPDU. In various embodiments, the second communication indicates a window of time protected by the first communication. For example, in various embodiments, the HEW AP 254A and/or the STA HEW 256A transmits one or more of the LR PPDU 510, 650, 750, 830, 1130, 1220, 1350, 1430, 1730, and/or 1830, the LR ACK 530, 660, 760, 840, 1030, 1140, 1230, 1360, 1440, 1630, 1740, and/or 1840, the LR RTS 620, 720, and/or 1320, the LR CTS 630, 740, and/or 1340, the LR poll 820, 920, 1020, 1120, 1420, 1520, 1620, and/or 1720, and the LRPN 1820 (FIGS. 5-18, respectively).

In various embodiments, the first communication can use a bandwidth greater than or equal to 20 MHz and the second communication can use a bandwidth less than 20 MHz. For example, the first communication can have a 20 MHz bandwidth. The second communication can have a 5 MHz bandwidth.

In various embodiments, the wireless device 402 can wait a predetermined amount of time before transmitting a third communication, the third communication being decodable by the second set of devices, and the first communication at least partially protecting the third communication. For example, the first communication can include a subsequent LR transmission. In various embodiments, the wireless device 402 receives a third communication, the first communication at least partially protecting the third communication.

In various embodiments, transmitting the first communication can include transmitting the first communication at a first power level and transmitting the second communication comprises transmitting the second communication at a second power level, the first power level being greater than the second power level. For example, the wireless device 402 can transmit one or more of the legacy PHYs 1210, 1310, 1330, 1410, 1510, 1610, 1710, and/or 1727 (FIGS. 12-17, respectively) at a higher power than a subsequent LR PHY, LR PPDU, etc.

In various embodiments, the wireless device 402 can further transmit a third communication, being decodable by the first set of devices, ending protection of communications of the frame being decodable by the second set of devices. For example, the HEW STA 256A can transmit one or more of the legacy CF-END frames 850, 950, 1050, 1150, 1450, 1550, 1650, and 1750 (FIGS. 8-17, respectively).

Furthermore, an apparatus for wireless communication for performing one or more of the above described features with respect to FIG. 19 may include means for transmitting a first communication at least partially protecting a second communication, the first communication being decodable by a first set of devices, and means for transmitting the second communication, the second communication being decodable by a second set of devices. In various embodiments, the apparatus may further include means for performing any other function described herein with respect to FIG. 19.

In an embodiment, means for transmitting a first communication at least partially protecting a second communication, the first communication being decodable by a first set of devices can be configured to perform one or more of the functions described above with respect to block 1910. In various embodiments, means for transmitting a first communication at least partially protecting a second communication, the first communication being decodable by a first set of devices can be implemented by one or more of the processor 404 (FIG. 4), the memory 406 (FIG. 4), the signal detector 418 (FIG. 4), the DSP 420 (FIG. 4), the HEW controller 424 (FIG. 4), the transmitter 410 (FIG. 4), the transceiver 414 (FIG. 4), and/or the antenna 416 (FIG. 4).

In an embodiment, means for transmitting the second communication, the second communication being decodable by a second set of devices can be configured to perform one or more of the functions described above with respect to block 1920. In various embodiments, means for transmitting the second communication, the second communication being decodable by a second set of devices can be implemented by one or more of the processor 404 (FIG. 4), the memory 406 (FIG. 4), the signal detector 418 (FIG. 4), the DSP 420 (FIG. 4), the HEW controller 424 (FIG. 4), the transmitter 410 (FIG. 4), the transceiver 414 (FIG. 4), and/or the antenna 416 (FIG. 4).

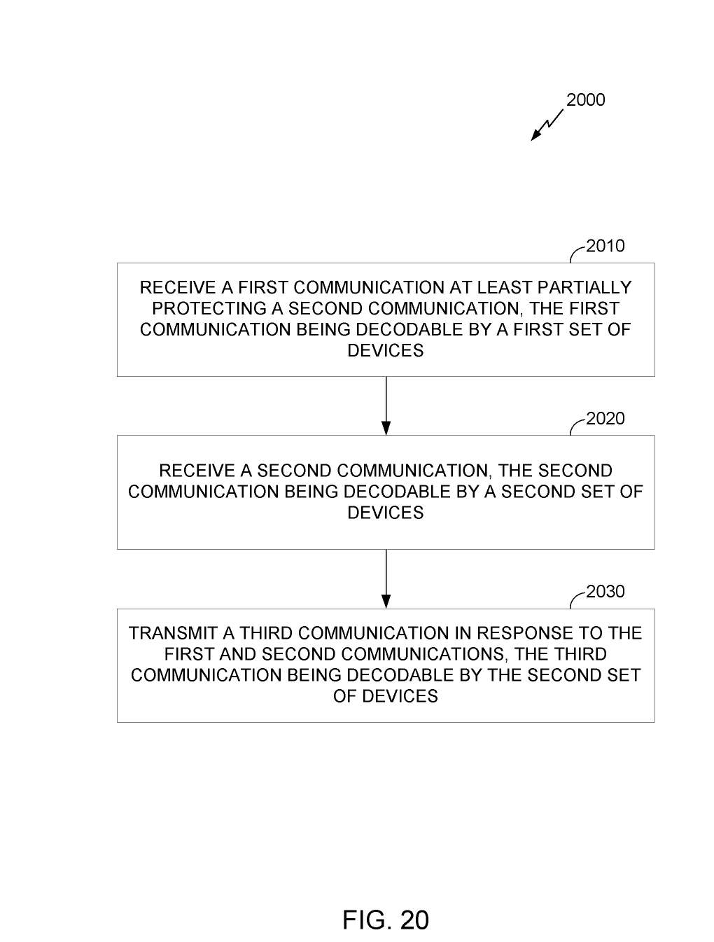

FIG. 20 is a flowchart 2000 of an exemplary method of wireless communication. Although the method of flowchart 2000 is described herein with reference to the wireless communication systems 100, 220, and 250 described above with respect to FIGS. 1-3 and the wireless device 402 described above with respect to FIG. 4, the method of flowchart 2000 can be implemented by another device described herein, any other suitable device, or any combination of multiple devices. In an embodiment, one or more steps in flowchart 2000 can be performed by a processor or controller such as, for example, the HEW controller 154 and/or 156A-156D (FIG. 1) and/or the HEW controller 424 (FIG. 4). Although the method of flowchart 2000 is described herein with reference to a particular order, in various embodiments, blocks herein can be performed in a different order, or omitted, and additional blocks can be added.

First, at block 2010, the wireless device 402 receives a first communication at least partially protecting a second communication, the first communication being decodable by a first set of devices. For example, in various embodiments, the HEW AP 254A and/or the STA HEW 256A receives one or more of the legacy CTS 510, 610, 640, 710, 740, 810, 910, 1010, 1110, and/or 1127 (FIGS. 5-12, respectively) and the legacy PI-W 1210, 1310, 1330, 1410, 1510, 1610, 1710, and/or 1727 (FIGS. 12-17, respectively).

In various embodiments, the first communication can include a clear-to-send (CTS) frame. For example, the first communication can include one or more of the legacy CTS 510, 610, 640, 710, 740, 810, 910, 1010, 1110, and/or 1127 (FIGS. 5-12, respectively). The CTS frame can set a NAV protecting one or more subsequent LR transmissions.

In various embodiments, the first communication can include a portion of a preamble for the second communication. For example, the first communication can include one or more of the legacy PHY 1210, 1310, 1330, 1410, 1510, 1610, 1710, and/or 1727 (FIGS. 12-17, respectively). In various embodiments, the first communication can include a preamble indicating a duration longer than a duration of a frame containing the preamble. For example, the preamble can include one or more of the spoofed durations 1215, 1315, 1335, 1415, 1515, 1615, and/or 1715 (FIGS. 12-17, respectively).

Next, at block 2020, the wireless device 402 receives a second communication, the second communication being decodable by a second set of devices. In various embodiments, the second communication includes a PPDU. In various embodiments, the second communication indicates a window of time protected by the first communication. For example, in various embodiments, the HEW AP 254A and/or the STA HEW 256A transmits one or more of the LR PPDU 510, 650, 750, 830, 1130, 1220, 1350, 1430, 1730, and/or 1830, the LR ACK 530, 660, 760, 840, 1030, 1140, 1230, 1360, 1440, 1630, 1740, and/or 1840, the LR RTS 620, 720, and/or 1320, the LR CTS 630, 740, and/or1340, the LR poll 820, 920, 1020, 1120, 1420, 1520, 1620, and/or 1720, and the LRPN 1820 (FIGS. 5-18, respectively).

Next, at block 2030, the wireless device 402 transmits a third communication in response to the first and second communications, the third communication being decodable by the second set of devices. In various embodiments, the third communication includes a PPDU. In various embodiments, the third communication indicates a window of time protected by the first communication. For example, in various embodiments, the HEW AP 254A and/or the STA HEW 256A transmits one or more of the LR PPDU 510, 650, 750, 830, 1130, 1220, 1350, 1430, 1730, and/or 1830, the LR ACK 530, 660, 760, 840, 1030, 1140, 1230, 1360, 1440, 1630, 1740, and/or 1840, the LR RTS 620, 720, and/or 1320, the LR CTS 630, 740, and/or1340, the LR poll 820, 920, 1020, 1120, 1420, 1520, 1620, and/or 1720, and the LRPN 1820 (FIGS. 5-18, respectively).

In various embodiments, the first communication can use a bandwidth greater than or equal to 20 MHz and the second and third communications can use a bandwidth less than 20 MHz. For example, the first communication can have a 20 MHz bandwidth. The second communication can have a 5 MHz bandwidth.

In various embodiments, transmitting the first communication can include transmitting the first communication at a first power level and transmitting the second and/or third communication comprises transmitting the second communication at a second power level, the first power level being greater than the second power level. For example, the wireless device 402 can transmit one or more of the legacy PHYs 1210, 1310, 1330, 1410, 1510, 1610, 1710, and/or 1727 (FIGS. 12-17, respectively) at a higher power than a subsequent LR PHY, LR PPDU, etc.

In various embodiments, the wireless device 402 can further transmit a fourth communication decodable by the first set of devices ending protection of communications with respect to the frames decodable by the second set of devices. For example, the HEW STA 256A can transmit one or more of the legacy CF-END frames 850, 950, 1050, 1150, 1450, 1550, 1650, and 1750 (FIGS. 8-17, respectively).

Furthermore, an apparatus for wireless communication for performing one or more of the above described features with respect to FIG. 20 may include means for receiving a first communication at least partially protecting a second communication, the first communication being decodable by a first set of devices, means for receiving a second communication, the second communication being decodable by a second set of devices; and means for transmitting a third communication in response to the first and second communications, the third communication being decodable by the second set of devices. In various embodiments, the apparatus may further include means for performing any other function described herein with respect to FIG. 20.

In an embodiment, means for receiving a first communication at least partially protecting a second communication, the first communication being decodable by a first set of devices can be configured to perform one or more of the functions described above with respect to block 2010. In various embodiments, means for receiving a first communication at least partially protecting a second communication, the first communication being decodable by a first set of devices can be implemented by one or more of the processor 404 (FIG. 4), the memory 406 (FIG. 4), the signal detector 418 (FIG. 4), the DSP 420 (FIG. 4), the HEW controller 424 (FIG. 4), the receiver 412 (FIG. 4), the transceiver 414 (FIG. 4), and/or the antenna 416 (FIG. 4).

In an embodiment, means for receiving a second communication, the second communication being decodable by a second set of devices can be configured to perform one or more of the functions described above with respect to block 2020. In various embodiments, means for receiving a second communication, the second communication being decodable by a second set of devices can be implemented by one or more of the processor 404 (FIG. 4), the memory 406 (FIG. 4), the signal detector 418 (FIG. 4), the DSP 420 (FIG. 4), the HEW controller 424 (FIG. 4), the receiver 412 (FIG. 4), the transceiver 414 (FIG. 4), and/or the antenna 416 (FIG. 4).

In an embodiment, means for transmitting a third communication in response to the first and second communications, the third communication being decodable by the second set of devices can be configured to perform one or more of the functions described above with respect to block 2030. In various embodiments, means for transmitting a third communication in response to the first and second communications, the third communication being decodable by the second set of devices can be implemented by one or more of the processor 404 (FIG. 4), the memory 406 (FIG. 4), the signal detector 418 (FIG. 4), the DSP 420 (FIG. 4), the HEW controller 424 (FIG. 4), the transmitter 410 (FIG. 4), the transceiver 414 (FIG. 4), and/or the antenna 416 (FIG. 4).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” covers: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above may also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

The claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication in an IEEE 802.11 wireless communication system including legacy and high-efficiency wireless (HEW) devices, comprising:
configuring transmission of a first communication for at least partially protecting reception of a second communication;
transmitting the first communication, the first communication being decodable by the legacy devices; and
transmitting the second communication, the second communication being decodable by the HEW devices.

2. The method of claim 1, wherein:
the first communication comprises a frame or at least a portion of a preamble for the second communication, thereby partially protecting reception of the second communication, and
the second communication comprises a frame.

3. The method of claim 2, wherein the first communication comprises a preamble indicating a duration longer than a duration of a frame containing the preamble, thereby partially protecting reception of the second communication.

4. The method of claim 1, wherein the second communication comprises a physical layer convergence protocol data unit.

5. The method of claim 1, wherein the first communication uses a bandwidth greater than or equal to 20 MHz, and the second communication uses a bandwidth less than 20 MHz.

6. The method of claim 1, wherein the first and second communications use a bandwidth greater than or equal to 20 MHz.

7. The method of claim 1, further comprising transmitting a third communication after waiting a predetermined amount of time, the third communication being decodable by the HEW devices, and wherein the transmitting of the first communication at least partially protects reception of the third communication.

8. The method of claim 1, wherein the transmitting of the first communication is at a first power level, and the transmitting of the second communication is at a second power level, the first power level being greater than the second power level, thereby partially protecting reception of the second communication.

9. The method of claim 1, wherein:
the first communication comprises a clear-to-send frame or a portion of a preamble for the second communication, thereby partially protecting reception of the second communication, and
the second communication comprises a ready-to-send frame.

10. The method of claim 9, wherein the method further comprises:
waiting a predetermined amount of time to receive a subsequent clear-to-send frame decodable by the HEW devices, wherein the transmission of the first communication at least partially protects reception of the subsequent clear-to-send frame; and
transmitting, after the earliest of receiving the subsequent clear-to-send frame or waiting the predetermined amount of time, a physical layer convergence protocol data unit decodable by the HEW devices, wherein the transmission of the first communication at least partially protects reception of the physical layer convergence protocol data unit.

11. An apparatus configured for wireless communication in an IEEE 802.11 wireless communication system including legacy and high-efficiency wireless (HEW) devices, comprising:
one or more processors; and
a transceiver configured to:
configure transmission of a first communication for at least partially protecting reception of a second communication;
transmit the first communication, the first communication being decodable by the legacy devices; and
transmit the second communication, the second communication being decodable by the HEW devices.

12. The apparatus of claim 11, wherein:
the first communication comprises a frame or at least a portion of a preamble for the second communication, thereby partially protecting reception of the second communication, and
the second communication comprises a frame.

13. The apparatus of claim 12, wherein the first communication comprises a preamble indicating a duration longer than a duration of a frame containing the preamble, thereby partially protecting reception of the second communication.

14. The apparatus of claim 11, wherein the second communication comprises a physical layer convergence protocol data unit.

15. The apparatus of claim 11, wherein the first communication uses a bandwidth greater than or equal to 20 MHz, and the second communication uses a bandwidth less than 20 MHz.

16. The apparatus of claim 11, wherein the first and second communications use a bandwidth greater than or equal to 20 MHz.

17. The apparatus of claim 11, the transceiver being further configured to transmit a third communication after waiting a predetermined amount of time, the third communication being decodable by the HEW devices, and wherein the transmitting of the first communication at least partially protects reception of the third communication.

18. The apparatus of claim 11, wherein the transmitting of the first communication is at a first power level, and the transmitting of the second communication is at a second power level, the first power level being greater than the second power level, thereby partially protecting reception of the second communication.

19. The apparatus of claim 11, wherein:
the first communication comprises a clear-to-send frame or a portion of a preamble for the second communication, thereby partially protecting reception of the second communication, and
the second communication comprises a ready-to-send frame.

20. The apparatus of claim 19, wherein the transceiver is further configured to:
wait a predetermined amount of time to receive a subsequent clear-to-send frame decodable by the HEW devices, wherein the transmission of the first communication at least partially protects reception of the subsequent clear-to-send frame; and
transmit, after the earliest of receiving the subsequent clear-to-send frame or waiting the predetermined amount of time, a physical layer convergence protocol data unit decodable by the HEW devices, wherein the transmission of the first communication at least partially protects reception of the physical layer convergence protocol data unit.

21. An apparatus comprising:
means for configuring transmission of a first communication for at least partially protecting reception of a second communication;
means for transmitting the first communication, the first communication being decodable by legacy devices; and
means for transmitting the second communication, the second communication being decodable by HEW devices.

22. A non-transitory computer-readable storage medium, comprising code that, when executed on one or more processors, causes an apparatus to:
configure transmission of a first communication for at least partially protecting reception of a second communication;
transmit the first communication, the first communication being decodable by legacy devices; and
transmit the second communication, the second communication being decodable by HEW devices.
